(19) United States
(12) Patent Application Publication
(10) Pub. No.: US 2004/0186801 A1
(43) Pub. Date: Sep. 23, 2004

(54) Charging system and charging method

(75) Inventor: Koma Morita, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/670,572

(22) Filed: Sep. 26, 2003

(30) Foreign Application Priority Data
Mar. 20, 2003 (JP) 2003-077024

(51) Int. Cl. G06F 17/60

(52) U.S. Cl. 705/32

(57) ABSTRACT

A client PC transmits a print job and drawing data. An image processing server transmits processing content information indicating the print job to a charging server. The charging server calculates a fee for a case where the process is completed normally, and then registers this calculated fee as a provisional accounting amount. The image processing server processes the drawing data to cause a printer to print the processed drawing data. When the printing fails, the image processing server outputs status information indicating this failure of the printing to the charging server. Upon receipt of this status information, the charging server discounts the provisional accounting amount stored in the accounting DB and determines this discounted accounting amount. Then, the charging server charges this discounted accounting amount to a user.

The present disclosure relates to the subject matter contained in Japanese Patent Application No.2003-77024 filed on Mar. 20, 2003, which is incorporated herein by reference in its entirety.

### BACKGROUND OF THE INVENTION

1. Field of the Invention

The present invention is related to a charging system and a charging method for charging for each of executed processes.

2. Description of the Related Art

For instance, JP-A-2003-5343, JP-A-2003-5931, and JP-A-2003-8870 disclose systems in which an image processing is requested from a client to a server, and then, the requested image processing is executed.

When the image processings are executed, it is required to charge for each of processings in response to modes of the processings flexibly.

Specifically, the following system may be conceived. A user's PC (personal computer) is connected via a network to a print system of a printing company. Drawing data, which is described in a language such as PostScript (registered trademark of Adobe system Inc.), is transmitted from the user to the printing company. The printing company executes a process (RIP (Raster Image Processing/Processor) processing) for expanding the transmitted drawing data into image data such as bitmap data. Furthermore, a color correcting processing and a printing processinging are executed with respect to this image data.

In such a system, for instance, it is assumed that fee for the RIP processing is charged the user every time the RIP processing is executed.

When a series of processes including the RIP processing and printing the bitmap data subjected to the color correcting processing are executed normally, no particular problem occurs to charge fee, which has been predetermined with respect to each processing.

Furthermore, when a user corrects a portion of a document and again prints the partially corrected document, there is a merit for the user if a partial fee is charged rather than the same amount of fee for subjecting the entire document to the RIP processing is charged.

To the contrary, for example, when bitmap data could be produced normally by executing the RIP processing and the color correcting processing, but the bitmap data cannot be printed normally due to a failure (malfunction) of a network, it is a great burden on a user to charge the user who requests printing of the same drawing data again for the same amount of fee as that for no failure. As a result, a demerit is given to the user.

### SUMMARY OF THE INVENTION

If the first bitmap data remains in a server, which executes these processings, new workloads for performing the RIP processing and the color correcting processing are not given to the printing company. This is because the printing company can reuse the remaining first bitmap data.

The present invention has been made to solve the above-described problem of the prior art. An object of the invention is to provide a charging system and a charging method, which can charge for each process in response to the modes of the processings flexibly.

Specifically, the charging method according to the invention changes an accounting amount for a re-executed processing to be cheaper than the predetermined fee or to be free of charge in response to details of the processings and conditions such as whether a processing is terminated normally or abnormally. As a result, the invention can protect a merit of the user.

[First Charging System]

In order to accomplish the above described object, a first charging system according to embodiments of the invention includes a process apparatus for executing a plurality of predetermined processings and a charging apparatus for charging for each executed processing. The process apparatus includes an information generation unit for generating process information indicating contents of the executed processings and status information indicating execution status of the processings, and an information transmission unit for transmitting the generated process information and the generated status information to the charging apparatus. The charging apparatus includes an information reception unit for receiving the transmitted process information and the transmitted status information, a fee calculation unit for calculating a fee for each executed processing on the basis of the received process information, an accounting amount determination unit for determining the calculated fees as an accounting amount when the received process information indicates that the executed processings are completed normally, and a charging unit for executing a charging processing on the basis of the determined accounting amount.

[First Charging Apparatus]

A first charging apparatus according to the embodiments of the invention charges for each predetermined processing, which a process apparatus executes. The process apparatus generates process information indicating contents of the executed processings and status information indicating execution status of the processings. The charging apparatus includes an information reception unit for receiving the process information and the status information, a fee calculation unit for calculating a fee for each executed processing on the basis of the received process information, an accounting amount determination unit for determining the calculated fees as an accounting amount when the received process information indicates that the executed processings are completed normally, and a charging unit for executing a charging processing on the basis of the determined accounting amount.

Preferably, the processings includes at least one of a raster image processing for expanding drawing data into bitmap data, a correction processing for correcting the expanded bitmap data, and a printing processing for printing the bitmap data.

Preferably, the charging apparatus further includes a provisional accounting amount holding unit for holding the calculated fees as provisional accounting amounts for the executed processings. When the process information indicates that the executed processings are completed normally, the accounting amount determination unit determines the held provisional accounting amounts as the accounting amount. When the process information does not indicate that the executed processings are completed normally, the accounting amount determination unit changes the held provisional accounting amounts and determines the changed provisional accounting amounts as the accounting amount.

[First Charging Method]

A first charging method according to the embodiment of the invention charges for each predetermined processing, which a process apparatus executes. The process apparatus generates process information indicating contents of the executed processings and status information indicating execution status of the processings. The charging method includes receiving the process information and the status information, calculating a fee for each executed processing on the basis of the received process information, determining the calculated fees as an accounting amount when the received process information indicates that the executed processings are completed normally, and executing a charging processing on the basis of the determined accounting amount.

### BRIEF DESCRIPTION OF DRAWINGS

FIG. 1 is a diagram for showing a configuration of a first print system to which a charging method according to the invention is applied.

FIG. 2 is a diagram for showing a hardware structure of a client PC, a printer, a colorimetric apparatus, an image processing server, and a charging server.

FIG. 3 is a diagram for showing a configuration of an RIP/color correcting program executed in the image processing server shown in FIGS. 1 and 2.

FIG. 4 is a diagram for showing a configuration of a charging program executed in the charging server shown in FIGS. 1 and 2.

FIG. 5 is a flow chart for showing a process (S10) of a fee changing section of the charging program shown in FIG. 1.

FIG. 6 is a diagram for showing a first normal sequence (S12) of the print system (FIG. 1).

FIG. 7 is a sequence diagram for showing a first operation (S14) at a time of printing failure in the print system (FIG. 1).

FIG. 8 is a sequence diagram for showing a second processing (S16) at a time of printing failure in the print system (FIG. 1).

FIG. 9 is a sequence diagram for showing an operation (S18) executed in a case where bitmap data for display operation and bitmap data for printing operation are generated in the image processing server (FIGS. 1 and 3).

FIG. 10 is a diagram for showing a second normal sequence (S22) of the print system (FIG. 1).

FIG. 11 is a sequence diagram for showing a third operation (S24) at a time of printing failure in the print system (FIG. 1).

FIG. 12 is a diagram for showing a third normal sequence (S26) of the print system (FIG. 1).

FIG. 13 is a sequence diagram for showing a fourth operation (S28) at a time of printing failure in the print system (FIG. 1).

FIG. 14 is a diagram for showing a configuration of a second print system to which an image processing method according to the invention is applied.

FIG. 15 is a first diagram for showing an outline of an RIP processing in the print system shown in FIG. 14.

FIG. 16 is a second diagram for showing an outline of an RIP processing in the print system shown in FIG. 14.

FIG. 17 is a third diagram for showing an outline of an RIP processing in the print system shown in FIG. 14.

FIG. 18 is fourth diagram for showing an outline of an RIP processing in the print system shown in FIG. 14.

FIG. 19 is a fifth diagram for showing an outline of an RIP processing in the print system shown in FIG. 14.

FIG. 20 is a diagram for showing a process for inserting a page into document data.

FIG. 21 is a sixth diagram for showing an outline of an RIP processing in the print system shown in FIG. 14.

FIG. 22 is a diagram for showing an arrangement of a second RIP/color correcting program for executing re-RIP processes shown in FIGS. 15 to 21, which is operated on the image processing server (FIG. 14).

FIG. 23 is a diagram for showing a configuration of a second image processing program for executing the re-RIP processing operation shown in FIGS. 15 to 21, which is operated on the client PC (FIG. 14).

FIG. 24 is a diagram for showing a configuration of a second image processing program for executing the re-RIP processing shown in FIGS. 15 to 21, which is operated on the printer (FIG. 14).

FIG. 25 is a flow chart for showing a process (S30) executed on the side of the client PC (image processing program) in the print system (FIG. 14).

FIG. 26 is a flow chart for showing a first process (S32) executed on the side of the image processing server (RIP/color correcting program 34) in the print system 2 (FIG. 14).

FIG. 27 is a flow chart for showing a process (partial RIP processing S36) subsequent to the second process executed on the side of the image processing server (RIP/color correcting program 34) in a case where the partial RIP processing is executed in the print system (FIG. 14).

FIG. 28 is a diagram for showing a configuration of a third RIP/color correcting program, which is operated on the image processing server (FIG. 14) in a second print system and executes a checking processing and an RIP processing with respect to image data.

FIG. 29 is a flow chart for showing a process (S40) of the third RIP/color correcting program shown in FIG. 28.

FIG. 30 is a diagram for showing a check function selecting image displayed by the RIP/color correcting program shown in FIG. 29.

FIG. 31 is a diagram for showing a check result displaying imaged is played in a case where the RIP/color correcting program shown in FIG. 29 detects a print inapplicable portion from drawing data.

### DETAILED DESCRIPTION OF PREFERRED EMBODIMENT OF THE INVENTION

[First Embodiment]

Next, a first embodiment of the invention will be described.

The below-mentioned print job contains two jobs, namely an RIP processing (may containing a color correcting processing), and a printing processing by a printer. Status information of each job is stored.

The status information includes image data (drawing data), a profile ID of profile data (described later) used in the RIP processing, image data subjected to the RIP processing, a time instant of the RIP processing, a printer, which performed a printing processing, and a result of a printed output. These components of the status information are stored in a table format as one entry with being associated with a job ID of the print job.

Generally speaking, image data includes image data such as a photograph, and code data such as a drawing command. In order to clearly indicate both the image data and the code data, an expression “image data (drawing data)” is used in the below-mentioned description.

When image data (drawing data), which has already been printed, is again printed, the status information is retrieved. Then, a judgment is made as to whether or not image data (drawing data) is present, which is identical to name/content of image data (drawing data) of a print job transmitted from a PC of a client and a profile ID of profile data used in a preceding RIP processing.

As a result of this judgment, it is found as to whether or not the same data as that obtained by executing the RIP processing with respect to image data (drawing data) to be printed at this time has already been stored.

When the same image data, which have already been subjected to the RIP processing, is present, since the existing image data may be merely printed without the same RIP processing, the RIP process is omitted. At this time, it may not be performed to charge for the RIP process, or an accounting amount may be discounted.

On the other hand, as a result of this judgment, when it is found that the same image data as that obtained by executing the RIP processing with respect to the image data (drawing data) to be printed has not be stored, the RIP process is again executed. Thus, it is executed as usual to charge for the RIP processing.

When the preceding printing processing failed, similar to the case where the reprinting processing is again executed, the status information is retrieved, and the judgment is made as to whether or not the same image data as that subjected to the RIP processing, which is to be printed in response to the print job received from the client's PC, has been stored.

When the same image data has been stored, similar to the case where the re-printing operation is executed, the RIP processing is omitted. It may not be performed to charge for the RIP processing or an accounting amount for the RIP processing may be discounted.

It should be noted that a series of the processings including the RIP processing, the color correcting processing, and the printing processing will also be referred to as a “processing group” hereinafter.

The status information indicating as to whether or not the series of the processing group is terminated normally is created for each processing contained in the processing group. However, in some cases, the status information is created for the entire processing group.

[Print System 1]

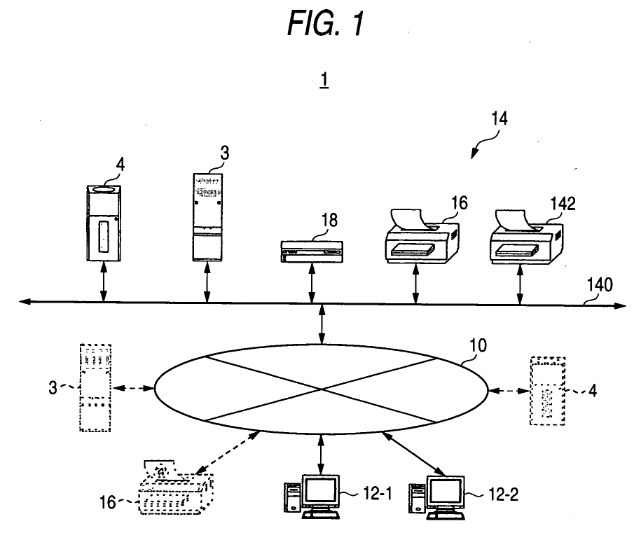

FIG. 1 is a diagram for showing an example of a configuration of a first print system 1 to which a charging method according to the invention is applied.

As shown in FIG. 1, the first print system 1 is configured so that a LAN (Local Area Network) system 14 of a printing company and client PCs 12-1 to 12-m of users of this LAN system 14 are connected to each other via a network 10 such as either a WAN (Wide Area Network) or the Internet, where m≧1 (in FIG. 1, m=2).

It should also be noted that for the sake of simplicity, in the below-mentioned drawings, lines indicating data flow and information flow between structural components are properly omitted.

The LAN system 14 is arranged so that an image processing server 3, a charging server 4, a calorimetric apparatus 18, a printer 16, and a printing machine 142, which is used when printing is carried out in large quantities (actual printing operation), are connected through a LAN 140.

When any of plural structural components such as the client PCs 12-l to 12-m is indicated without specifying, this structural component, is simply abbreviated as a “client PC 12.”

In this first print system 1, the LAN system 14 may provide functions such as an RIP processing, a color correcting processing, and a printing with the client PC 12 with using the structural components. Every time the first print system 1 executes a processing to realize any of the functions, this print system 1 charges the users in various ways.

[Hardware Configuration]

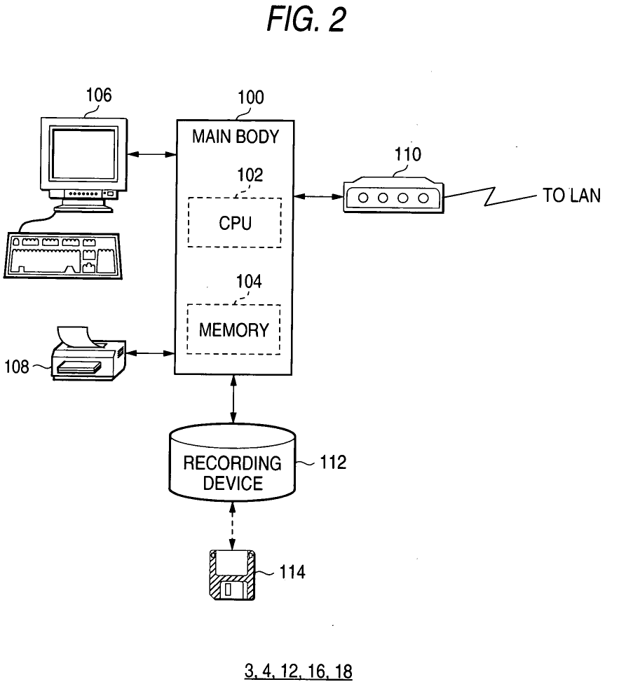

FIG. 2 is a diagram for showing an example of hardware configurations of the client PC 12, the printer 16, the calorimetric apparatus 18, the image processing server 3, and the charging server 4.

As shown in FIG. 2, the client PC 12 and the like include either a PC (personal computer) or a main body 100 of a control apparatus, a display/input device 106, a function realizing unit 108, a communication device 110, and a recording device 112. Either the PC or the main body 100 of the control apparatus contains a CPU 12, a memory 104, and peripheral circuits thereof. The display/input device 106 contains a display device, a keyboard, and a mouse. The function realizing unit 108 is used to realize functions peculiar to each device. The function realizing unit 108 may include a printer engine in the printer 16. The communication device 110 realizes a communication function with respect to the LAN 140 or the network 10. The recording device 112 may be an HDD (hard disk drive) and a CD (compact disk).

In other words, the client PC 12, the printer 16, the image processing server 3, and the charging server 4 include structural components serving as a computer, which communicates with the other devices (hereinafter, referred to as a node) through the network 10 or the LAN 140.

[Client PC 12]

The client PC 12 (FIGS. 1 and 2) transmits image data to the LAN system 14, and requests this LAN system 14 to execute the RIP processing, the color correcting processing, and the printing processing with respect to this transmitted image data.

[Colorimetric Apparatus 18]

The colorimetric apparatus 18 measures colors of a printed matter, which is obtained as a result of color printing performed by the printer 16 and the printing machine 142 for performing the actual printing.

The calorimetric apparatus 18 furthermore produces device link profile data (DLP data) on the basis of parameters (target profile (TP) data) indicating color characteristics of the printer 16 and parameters indicating color characteristics of the printing machine 142 for performing the actual printing and outputs the DLP data to the image processing server 3.

This DLP data is used to perform the color correction processing with respect to bitmap data in order to obtain a printing result having the same color characteristics of the printing machine 142 from the printer 16.

[First Rip/Color Correcting Program 30]

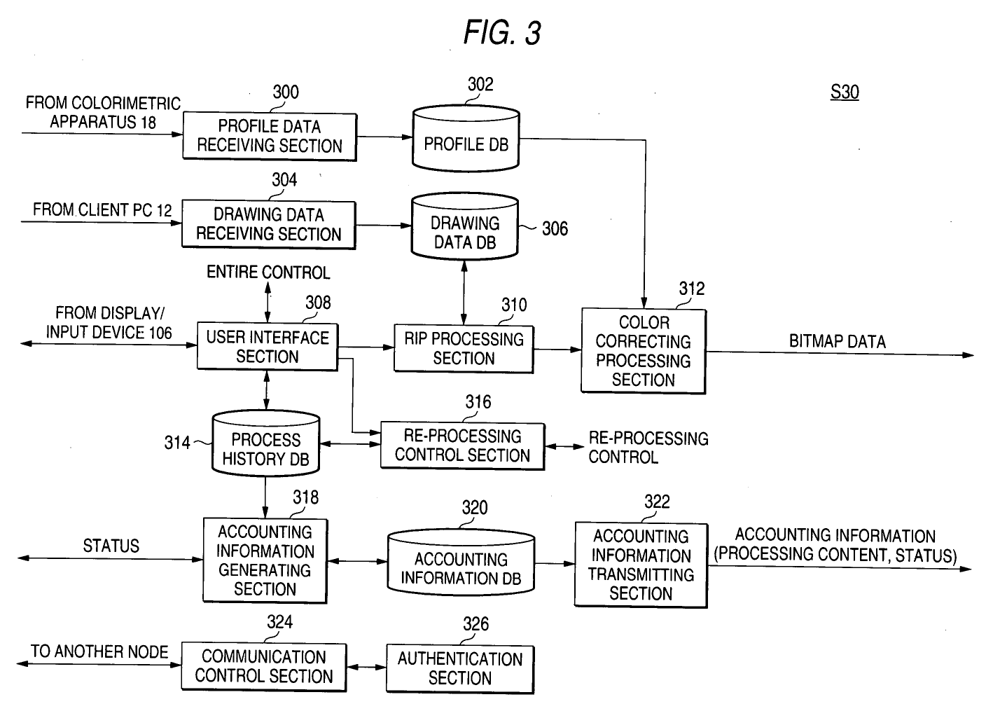

FIG. 3 is a schematic diagram for showing a configuration of a first RIP/color correcting program 30, which is executed in the image processing server 3 shown in FIGS. 1 and 2.

As shown in FIG. 3, the first RIP/color correcting program 30 includes a target profile data receiving section (profile data receiving section) 300, a profile database (profile DB) 302, a drawing data receiving section 304, a drawing data DB 306, a user interface section (UI section) 308, an RIP processing section 310, a color correcting processing section 312, a process history DB 314, a re-processing control section 316, an accounting information generating section 318, an accounting information DB 320, and an accounting information transmitting section 322.

It should also be noted that for the sake of simplicity in FIG. 3, lines for indicating flow of information/data are properly omitted.

The first RIP/color correcting program 30 is supplied via, for instance, a recording medium 114 (FIG. 2) to the image processing server 3, and then is loaded into the memory 104 to be executed.

The first RIP/color correcting program 30 receives image data from the client PC 12 and executes the RIP processing and the color correcting processing by means of these structural components.

Also, the first RIP/color correcting program 30 generates accounting information (accounting information and status information) required for charging, and then outputs the generated accounting information to the charging server 4.

The profile data receiving section 300 receives the DLP data of the printer 16 from the colorimetric apparatus 18 (FIGS. 1 and 2) and then, stores the received DLP data in the profile DB 302.

The drawing data receiving section 304 receives drawing data, which is described in a printing language, e.g., Post Script (registered trademark of Adobe System Inc.), from the client PC 12 and then, stores the received drawing data in the drawing data DB 306.

The UI section 308 provides an UI image used to operate the image processing server 3 (first RIP/color correcting program 30) and the printer 16 to, for example, the client PC 12. The UI section 308 accepts operations of a user with respect to this UI image to output the accepted user's operations to the RIP processing section 310.

Also, the UI section 308 accepts operation of the user from the client PC 12, and generates processing content information indicating content of a processing, which is requested to the image processing server 3 and the printer 16. Then, the UI section 308 stores the generated processing content information in the accounting information DB 320.

The UI section 308 controls processings of each structural component of the RIP/color correcting program 30 one the basis of operations of the user, which are accepted in the above-described manner.

Also, the UI section 308 stores a history of the accepted user's operations in the process history DB 314.

The RIP processing section 310 executes the RIP processing with respect to the drawing data stored in the drawing data DB 306 in accordance with the operation of the user, which is accepted through the UI section 308, to generate bitmap data for a printing.

The RIP processing section 310 outputs the generated bitmap data to the color correcting processing section 312. The RIP processing section 310 also stores the generated bitmap data in the drawing data DB 306, if necessary.

The color correcting processing section 312 performs a color correcting processing using the DLP data stored in the profile DB 302 with respect to the bitmap data input from the RIP processing section 310 or the bitmap data, which is acquired as a retrieving result in the drawing data DB 306, in accordance with the operation of the user accepted through the UI section 308, if necessary.

The color correcting processing section 312 outputs the color-corrected bitmap data to the printer 16. The color correcting processing section 312 also stores this color-corrected bitmap data in the drawing data DB 306, if necessary.

Alternatively, when the first RIP/color correcting program 30 generates bitmap data to be displayed on the display/input device 106 of the client PC 12, the color correcting processing section 312 outputs the generated bitmap data to the client PC 12.

When a re-execution of a preceding processing, which has failed, is requested from the client PC 12 through the UI section 308, the re-processing control section 316 refers to the processing content information and the status information, which are stored in the process history DB 314, to acquire an optimum re-processing method, and then, re-executes the processing.

For example, when the drawing data received from the client PC 12 is still remained in the drawing data DB 306, the re-processing control section 316 controls each of structural components of the first RIP/color correcting program 30 and the printer 16 in order that a series of processings such as the RIP processing, the color correcting processing, and the printing processing with respect to the remaining drawing data.

Also, for example, when bitmap data, which has already been subjected to the RIP processing and the color correcting processing, is remained in the drawing data DB 306, the re-processing control section 316 controls the printer 16 and each of structural components of the first RIP/color correcting program in such a manner that the remaining bitmap data is subjected to the printing processing.

The accounting information generating section 318 processes the histories of the operations by the user, which are stored in the process history DB 314, and status information such as a success in printing/fail in printing returned from the printer 16 to generate printing processing information indicating content of a processing requested from the user and status information indicating a status of a processing. Then the accounting information generating section 318 stores the generated printing processing information and the generated status information in the accounting information DB 320.

The processing content information generated by the accounting information generating section 318 includes general information, which may give influences to an accounting amount, such as total number of print materials requested for the printer 16, distinction of color printing/monochrome printing, and a designation of a printing quality.

Also, the status information generated by the accounting information generating section 318 contains, for example, the below-mentioned general information, which may be a reason for changing the accounting amount:

(1-1) When a processing to be charged is executed, information indicating that the processing is a first processing, or that the processing is the same processing and how many times the processing has been executed (execution time information).

(1-2) When a processing to be charged is executed, information indicating that the processing is a re-execution of a processing, which was filed once in some reason (re-processing information).

(1-3) When a processing to be charged is re-executed, information indicating the reason why a preceding process was failed (re-process reason information).

This information includes, for instance, information indicating that out of a paper, running out of a toner, or a paper jam of the printer 16, which is contained in a notification issued from the printer 16 when a printing processing fails.

(1-4) When a processing to be charged is executed, information indicating as to whether or not another processing related to this process is present (related processing information).

For example, when a processing for displaying certain bitmap data on the client PC 12 is executed, the related processing information indicates as to whether the bitmap data to be processed by this display processing is bitmap data, which has already been subjected to the relative RIP processing/color correcting processing, or as to whether or not bitmap data, which has been generated for this display processing.

(1-5) information indicating what method the re-processing control section 316 executes the re-processing in (re-processing method information).

(1-6) When a plurality of processings to be charged are executed, information indicating as to whether or not each of processings succeed (success processing information).

The accounting information transmitting section 322 outputs the accounting information (the processing content information and the status information), which is stored in the accounting information DB 320, to the charging server 4.

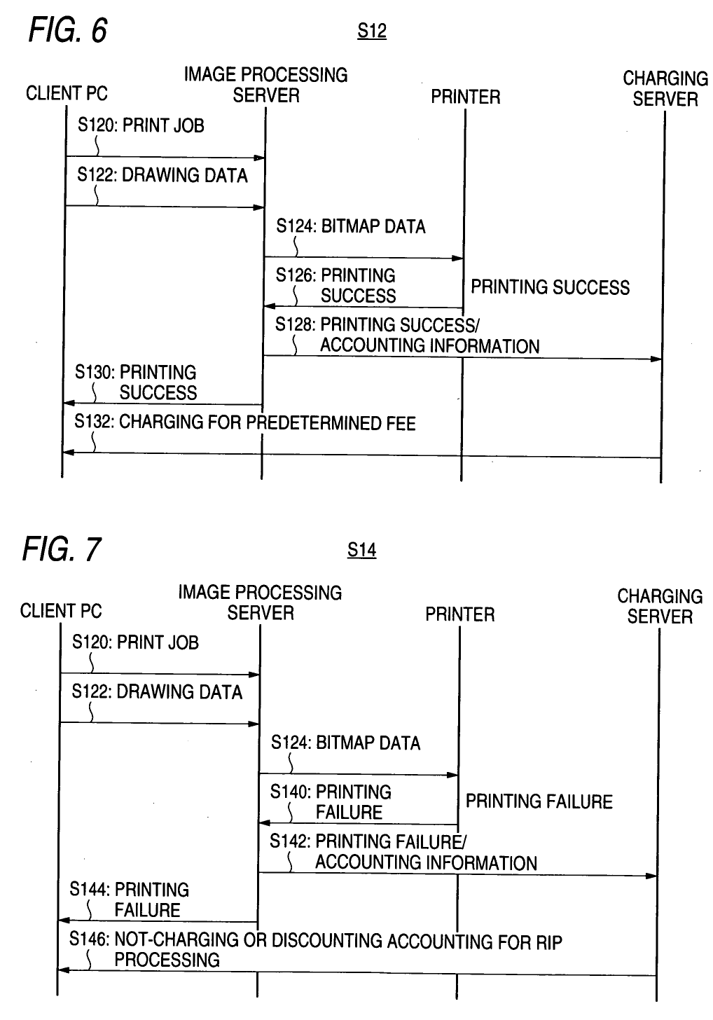

The communication control section 324 performs a communication control between the first RIP/color correcting program 30 and other nodes to realize a communication sequence shown in FIG. 6.

The authentication section 326 executes an authentication processinging of the client PC 12, which requests the image processing server 3 to perform an image processing.

[Charging Program 40]

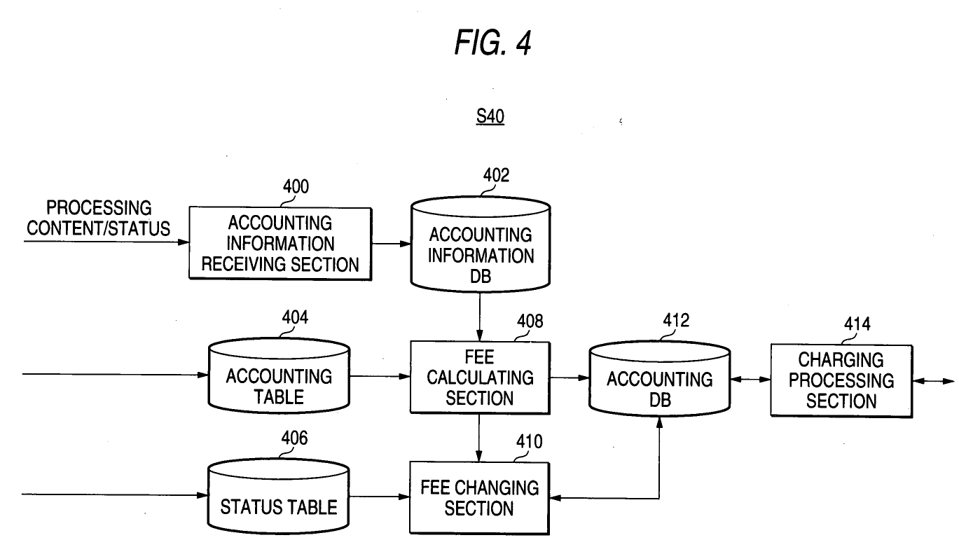

FIG. 4 is a diagram for schematically showing a configuration of a charging program 40, which is executed by the charging server 4 shown in FIGS. 1 and 2.

As shown in FIG. 4, the charging program 40 includes an accounting information receiving section 400, an accounting information DB 402, an accounting table 404, a status table 406, a fee calculating section 408, a fee changing section 410, an accounting DB 412, and a charging processing section 414.

The charging program 40 is supplied via, for example, the recording medium 114 (FIG. 2) to the charging server 4, and then is loaded on the memory 104 to be executed.

The charging program 40 calculates fee for each processings executed by the image processing server 3 on the basis of the accounting information (the processing content information) input from the image processing server 3 (first RIP/color correcting program 30), using the structural components thereof.

Also, the charging program 40 discounts the calculated fee, changes the calculated fee to be free of charge, or increases the calculated fee in a particular case where a further processing is added in a midway, using the accounting information (the status information) input from the image processing server 3, if necessary.

The accounting information receiving section 400 receives the accounting information from the image processing server 3, and then stores this received accounting information in the accounting information DB 402.

The accounting table 404 is supplied from an external via, for example, the recording medium 114 (FIG. 2), or is set by a user of the charging server 4, who operates the display/input device 106.

The accounting table 404 holds therein unit price of fee with respect to each item of the processing content information received from the image processing server 3, and outputs the held unit prices to the fee calculating section 408.

In other words, for instance, the accounting table 404 stores thereinto a plurality of items such as the printing quality and the distinction of the color printing/monochrome printing combined with each other, and data of unit prices of the RIP processing, the color correcting processing, and the printing processing, which correspond to these items. The accounting table 404 outputs the combined items and the unit price data to the fee calculating section 408.

The fee calculating section 408 calculates each fee of a processing indicated by the processing content information with reference to the unit price data of the fees stored in the accounting table 404.

The fee calculating section 408 divides each fee of the processing obtained as the calculation results every user of the client PC 12, and outputs the divided fees to the fee changing section 410, or stores the divided fees in the accounting DB 412.

Similar to the accounting table 404, the status table 406 is supplied from the external by the print system 114 (FIG. 2), or is set by the user of the charging server 4, who operates the display/input device 106.

The status table 406 stores thereinto change data indicating a discount rate of a fee, an increase rate of a fee, or no charge with respect to each of combinations of the status information, and outputs the change data to the fee changing section 410.

The fee changing section 410 changes either a fee for each processing, which is input from the fee calculating section 408, or a fee for each processing, which is read from the charging database 412, with reference to the change data of the status table 406. The fee changing section 410 divides the changed fee every user of the client PC 12 and stores the divided changed fees in the fee changing section 410.

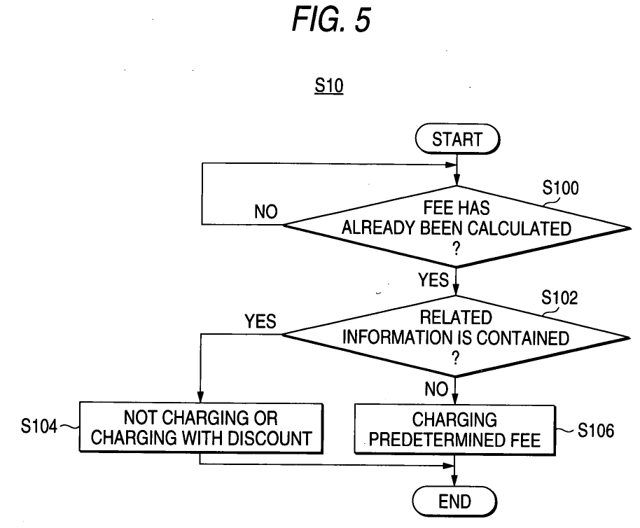

Referring now to FIG. 5, the process of the fee changing section 410 will be further described while a case where the fee changing section 410 judges the related processing information contained in the status information is taken as an example.

FIG. 5 is a flow chart for explaining a processing (S10) of the fee changing section 410 of the charging program 40 shown in FIG. 4.

As shown in FIG. 5, the fee changing section 410 judges as to whether or not the fee is calculated by the fee calculating section 408 in a step 100 (S100).

The process of the fee changing section 410 is advanced to a further process of a step S102 when the fee is calculated by the fee calculating section 408, whereas in other cases than the above case, the process of the step S100 remains.

In the step 102 (S102), the fee changing section 410 judges as to whether or not the related processing information is contained in the status information of the processing, the fee for which has been calculated.

When the related processing information is contained in the status information, the process of the fee changing section 410 advances to a process of a step S104, whereas in other cases than the above case, the process of the fee changing section 410 advances to a process of a step S106.

In this step 104 (S104), the fee changing section 410 refers to the change data of the status table 406 to change the predetermined fee calculated by the fee changing section 410, and then stores the changed predetermined fee in the accounting DB 412.

With regard to the processing, which is a target of the fee calculation, the charging processing section 414 charges the user of the client PC 12 for the discounted fee stored in the accounting DB 412 or does not charge.

In the step 106 (S106), the fee changing section 410 refers to the change data of the status table 406, and stores the predetermined fee calculated by the fee changing section 410 into the accounting DB 412 without changing the predetermined fee.

With regard to the processing, which is a target of the fee calculation, the accounting processing section 414 charges the user of the client PC 12 for the predetermined fee stored in the accounting DB 412.

It should be noted that the process shown in FIG. 5 is commonly applied to each information contained in the status information. When plural pieces of information are contained in the status information, the process shown in FIG. 5 is carried out with respect to combinations of the plural pieces of information.

[Operation of Print System 1]

Referring now to FIG. 6 to FIG. 9, an entire operation of the print system 1 will be described.

Each sequence shown in FIGS. 6 to 9 is shown as a specific example for the sake of helping to understand the invention. It should be noted that the operation of the print system 1 is not limited to these examples.

[Normal Sequence 1]

First, a description is made of an operation of the print system 1 when the RIP processing and the color correcting processing or one of the RIP processing and the color correcting processing, and the printing processing are executed with respect to drawing data normally.

It should also be understood that processings of the below-mentioned each embodiment may be executed in combination with each other by changing the processings suitable or so long as the combination does not cause inconsistency.

FIG. 6 is a diagram for indicating a first normal sequence (S12) of the print system 1 (FIG. 1).

As shown in FIG. 6, an authentication processing is executed between the client PC 12 and the image processing server 3 (first RIP/color correcting program 30; FIG. 3). The image processing server 3 authenticates the client PC 12.

The client PC 12 designates the contents of the RIP/color correcting processing, and the printing processing (print job), and then transmits drawing data, which is to be subjected to these processings (S120 and S122).

It should also be noted that the print job contains information indicating a job ID, user name, and ID for specifying the DLP data in addition to information indicating the contents of the RIP/color correcting processing and the printing processing (print job).

The UI section 308 of the RIP/color correcting program 30 generates the processing content information indicating the content of this print job and then, stores the processing content information in the accounting information DB 320.

The image processing server 3 executes the RIP/color correcting processing in accordance with the process contents designated by the client PC 12 to generate bitmap data (BM data), and designates a printing method to output the generated BM data and the designated printing method to the printer 16 (S124) The printer 16 prints the bitmap data from the image processing server 3, and when the printing is accomplished normally, the printer 16 notifies a printing success to the image processing server 3 (S126).

The image processing server 3 outputs the accounting information to the charging server 3 (the charging program 40; FIG. 4) (S128). This accounting information includes the processing content information and the execution time information (the status information) indicating that the printing processing succeeds and the processing to be charged is a first processing.

The image processing server 3 notifies the success of the printing processing to the client PC 12 (S130).

Upon receipt of this accounting information, the charging server 4 executes a processing for charging the user of the client server 12 for the predetermined accounting (S132).

Speaking in detail, the charging program 40 charges, for example, the client PC 12 for a predetermined fee for the RIP/color correcting processing, and another fee for the printing processing

[Print Failure Sequence 1]

Next, a description will be made on an operation in which although the RIP/color correcting processing with respect to drawing data succeeds, the printing processing for the drawing data is failed in the print system 1.

FIG. 7 is a sequence diagram for showing a first operation (S14) at a time of printing failure in the print system 1 (FIG. 1).

It should be noted that the same reference numerals shown in the sequence of FIG. 6 will be employed as those for denoting essentially same sequence shown in FIG. 7.

As shown in FIG. 7, the client PC 12 transmits a print job and drawing data to the image processing server 3. Then, the image processing server 3 transmits bitmap data, which has been obtained as a result of the RIP/color correcting processing to the printer 16 (S120 to S124).

When the printer 16 fails in the printing of the bitmap data received from the image processing server 3 (the RIP/color correcting program 30; FIG. 3) due to a certain reason, this printer 16 notifies a failure of the printing to the image processing server 3 (S140).

It should also be noted that this failure notification of the printing includes information indicating some causes (paper depletion, paper jam, toner depletion etc.) why the printing fails.

The image processing server 3 outputs the accounting information to the charging server (the charging program 40; FIG. 4) (S142). This accounting information includes the processing content information and the status information containing success processing information indicating that the RIP/color correcting processing have succeeded and the printing processing has failed.

The image processing server 3 notifies this failure of the printing to the client PC 12 (S144).

Upon receipt of this accounting information, the fee changing section 410 of the charging server 4 discounts a fee, which has been calculated by the fee calculating section 408 and has been stored in the accounting DB 412. Then, the charging processing section 414 executes a processing for charging the user of the client PC 12 with discount (S146).

Speaking in more detail, for example, when the LAN system 14 causes the failure of the printing, the charging program 40 charges the client PC 12 for the discounted fee for the RIP/color correcting processing.

As described above, with regard to the status information indicating either success or failure of a processing, there are two cases. In one case, the status information is generated for each of series of plural processings. In the other case, the status information is generated for the entire series of the plural processings (processing group).

A designer can suitably select whether to use the status information for each processing or to use the status information for the entire processing group, in response to the system configuration or the content of the processing.

For example, in the charging processing, when it is necessary to manage the status of each of plural processings contained in the processing group, it may be designated to generate the status information for each processing.

Alternatively, when print jobs designated by a user are executed as the processing group, and any one of the plural processings failed, but it is necessary to notify that the processing group failed as a whole, it may be designated to generate the status information for the entire processing group.

[Print Failure Sequence 2]

Next, a description will be made on an operation in which although the RIP/color correcting processing with respect to drawing data succeeded, the printing processing for the drawing data has failed in the print system 1, and then, this processing is re-executed.

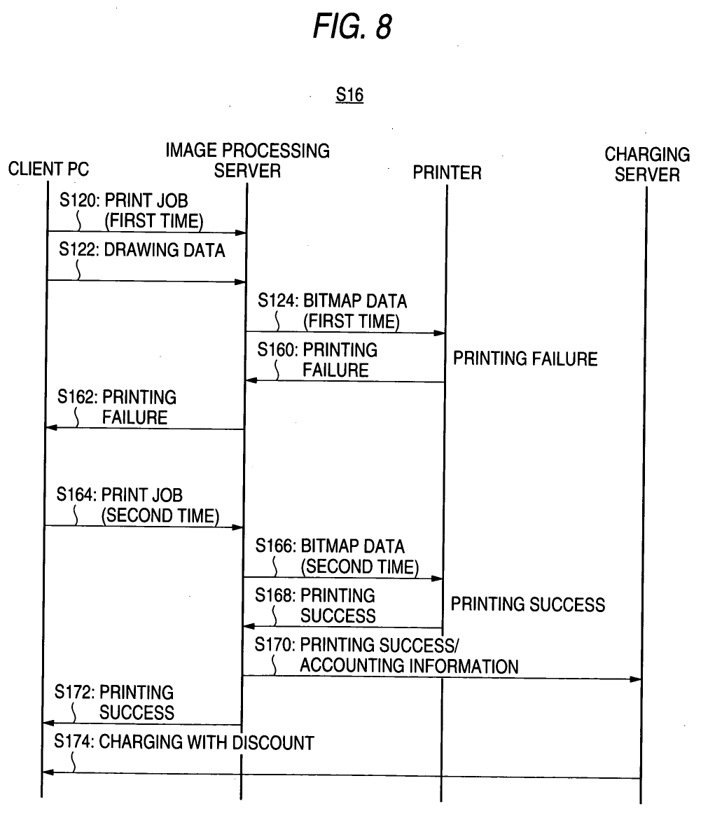

FIG. 8 is a sequence diagram for showing a second operation (S16) at a time of printing failure in the print system 1 (FIG. 1).

It should be noted that the same reference numerals shown in the sequence of FIGS. 6 and 7 will be employed as those for denoting essentially same sequence shown in FIG. 8.

As shown in FIG. 8, the client PC 12 transmits a print job and drawing data to the image processing server 3. Then, the image processing server 3 transmits bitmap data, which has been obtained as a result of the RIP/color correcting processing to the printer 16 (S120 to S124).

When the printer 16 fails in a printing of the bitmap data received from the image processing server 3 (the first RIP/color correcting program 30; FIG. 3) due to a certain reason, this printer 16 notifies a failure of this first printing to the image processing server 3 (S160).

The image processing server 3 notifies this failure of the printing operation to the client PC 12 (S162).

When the user of the client PC 12 requests the image processing server 3 to re-execute the same processing (second print job) as the failed processing (S164), the re-processing control section 316 of the RIP/color correcting program 30 selects an optimum re-processing method.

For instance, when the re-processing control section 316 transmits the bitmap data, which has already been subjected to the RIP/color correcting processing and has been stored in the drawing data DB 306, to the printer 16 and selects a method for a printing, the color correcting processing section 312 reads the bitmap data from the drawing data DB 306 to output this read bitmap data to the printer 16 (S166).

When the printer 16 prints the bitmap data supplied from the image processing server 3 and then completes the printing normally, the printer 16 notifies a success of the printing to the image processing server 3 (S168).

The image processing server 3 outputs accounting information to the charging server 4 (the charging program 40; FIG. 4) (S170). This accounting information includes the processing content information and the status information containing re-processing information and re-processing reason information. This re-processing information indicates that the printing has succeeded, which has been re-executed after the printing once failed.

The image processing server 3 notifies the success of the printing to the client PC 12 (S172) Upon receipt of this accounting information, the fee changing section 410 of the charging server 4 discounts a fee, which has been calculated by the fee calculating section 408 and has been stored in the accounting DB 412. The charging processing section 414 charges the user of the client PC 12 with discount (S174).

Speaking in more detail, for example, the charging program 40 charges the client PC 12 for the predetermined fee for the first RIP/color correcting processing, the discounted fee for the second RIP/color correcting processing, and further the predetermined fee for the printing processing.

[Use of Related Information]

A description will now be made on an operation of the print system 1 when bitmap data to be displayed on the display/input device 106 of the client PC 12 and bitmap data to be subjected to the printing processing in the printer are generated.

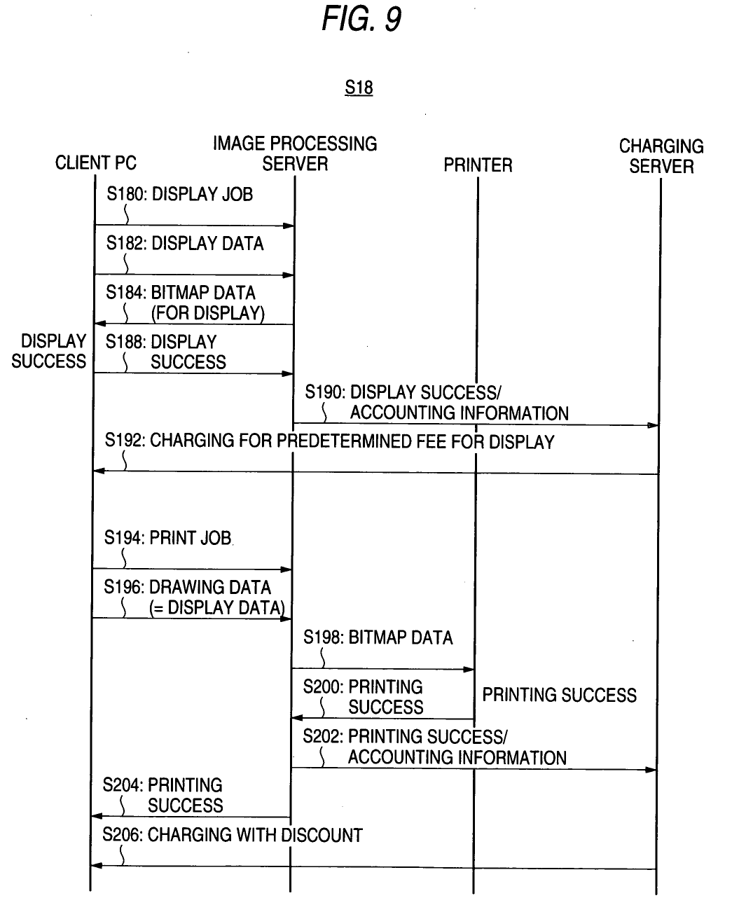

FIG. 9 is a sequence diagram for indicating an operation (S18) when the bitmap data for display and the bitmap data for printing are generated in the image processing server 3 (FIGS. 1 and 2).

As shown in FIG. 9, the client PC 12 outputs a display job and drawing data to the image processing server 3 (S180 and S182). The display job indicates a processing for generating the bitmap data to be displayed on the display/input device 106 of the client PC 12.

The image processing server 3 (first RIP/color correcting program 30; FIG. 3) generates the bitmap data for the display, and then outputs the generated bitmap data to the client PC 12 (S184).

When the client PC 12 succeeds in the display of the bitmap data output from the image processing server 3, the client PC 12 notifies this success of the display to the image processing server 3 (S186).

The image processing server 3 transmits the processing content information and the status information to the charging server 4 (S190). The status information indicates success processing information indicating the success of the RIP/color correcting processing for the bitmap data for display.

With regard to the RIP/color correcting processing for the bitmap data for display, the charging server 4 (the charging program 40; FIG. 4) charges the client PC 12 in a predetermined manner (S192) The client PC 12 outputs to the image processing server 3, the print job and the same drawing data as the drawing data (display data) received at the step S162 (S194 and S196).

The re-processing control section 316 judges as to whether or not the display job is equal to the drawing job on the basis of, for example, either comparison of explicit instructions by the user of the client PC 12, comparison of the display data (S182) and the drawing data (S196), or comparison between the content of the display job and the content of the print job.

When the re-processing control section 316 judges that these display/drawing jobs are equal to each other, the re-processing control section 316 makes the display/drawing jobs be associated with each other and to be regarded as the related processings.

For example, when the bitmap data generated during the execution of the display job is still remained in the drawing data DB 306, the re-processing control section 316 outputs this remained bitmap data to the printer 16 (S198).

When the printer 16 succeeds in the printing processing of the bitmap data output from the image processing server 3, the printer 16 notifies this success to the image processing server 3 (S200).

The image processing server 3 outputs the processing content information and the status information to the charging server 4 (charging program 40; FIG. 4) (S202). The status information contains the related processing information indicating that the display job and the print job are related processings to each other.

The image processing server 3 notifies the success of the printing to the client PC 12 (S204).

The charging server 4 charges the client PC 12 with taking the predetermined fee off. (S206).

Speaking in more detail, for instance, the charging program 40 doesn't charge the client PC 12 for the first RIP/color correcting processing in the print job but charges the client PC 12 for only the printing processing.

It should also be understood that as indicated by a dotted line in FIG. 1, each apparatus contained in the LAN system 14, e.g., the charging server 4 may be directly connected to the network 10.

Also, the function sharing among the structural components (nodes) contained in the print system 1 such as the LAN system 14 and the image processing server 3 has been described as an example. The function sharing among these nodes may be set desirably. For example, a part of the function owned by the image processing server 3 may be shared by the client PC 12.

It should also be noted that each item described in the above description may be similarly applied to the following embodiments.

[Second Embodiment]

A second embodiment of the invention will be described.

In the second embodiment, the following points are modified in comparison with the first embodiment. The image processing server 3 transmits the processing content information to the charging server 4 immediately after receiving the print job from the client PC 12. The image processing server 3 transmits the status information to the charging server 4 after receiving a notification of a result of the printing processing executed by the printer 16. Details of the modification will be described later.

Also, a process of the charging server 4 of the second embodiment is changed as follows. When the charging server 4 receives print content information from the image processing server 4, generates and registers provisional accounting information, and receives the status information, the charging server 4 determines the provisional accounting information.

[Normal Sequence 2]

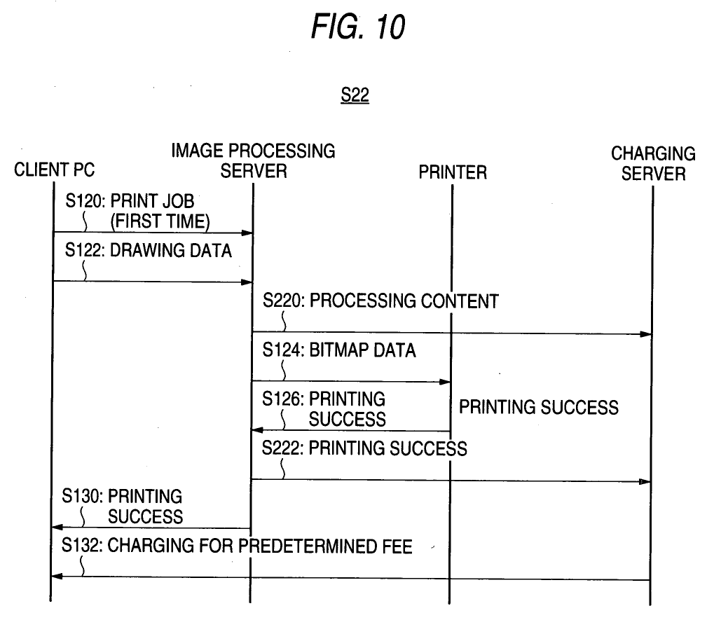

FIG. 10 is a sequence diagram for representing a second normal sequence (S22) in the print system 1 (FIG. 1).

It should be noted that the same reference numerals shown in the sequence of FIG. 6 will be employed as those for denoting essentially same sequence shown in FIG. 10.

As shown in FIG. 10, the client PC 12 designates content of a print job, and transmits drawing data to be processed (S120 and S122).

The UI section 308 of the RIP/color correcting program 30 generates processing content information indicating the contents of this print job and then, stores this processing content information in the accounting information DB 320.

The accounting information transmitting section 322 outputs accounting information containing the processing content information stored in the accounting information DB 320 to the charging server 4 (S220).

The image processing server 3 processes the drawing data in accordance with the processing content designated by the client PC 21 to generate bitmap data, designates a printing method, and outputs the generated bitmap data and the designated printing method to the printer 16 (S124).

The printer 16 prints the bitmap data supplied from the image processing server 3. When the printing is finished normally, this printer 16 notifies a success of the printing to the image processing server 3 (S126).

The image processing server 3 outputs to the charging server 3 (charging program 40; FIG. 4) accounting information containing the processing content information and execution time information (status information) indicating that the printing succeeds and the processing to be charged is a first processing (S222).

The image processing server 3 notifies the success of the printing to the client PC 12 (S130).

Upon receipt of this accounting information, the charging server 4 charges the user of the client PC 12 for the predetermined accounting (S132).

[Print Failure Sequence 3]

Next, a description will be made on an operation in which although RIP/color correcting processing with respect to drawing data succeeded, a printing processing for this drawing data has failed in the print system 1.

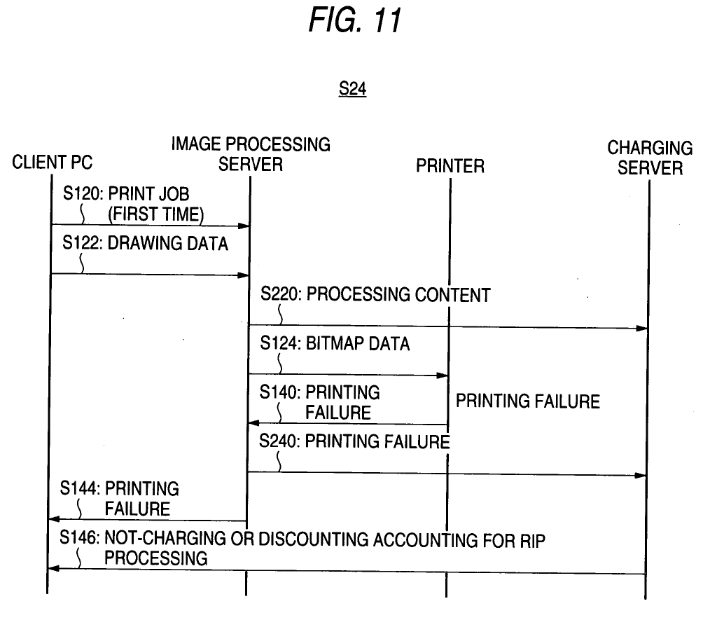

FIG. 11 is a sequence diagram for showing a third operation (S24) at a time of printing failure in the print system 1 (FIG. 1).

It should be noted that the same reference numerals shown in the sequence of FIGS. 6 and 7 will be employed as those for denoting essentially same sequence shown in FIG. 11.

As shown in FIG. 11, the client PC 12 transmits a print job and drawing data to the image processing server 3. Then, the image processing server 3 transmits bitmap data, which has been obtained as a result of RIP/color correcting processing, to the printer 16 (S120 to S124).

The UI section 308 of the RIP/color correcting program 30 generates processing content information indicating the contents of this print job, and then, stores this processing content information in the accounting information DB 320.

The accounting information transmitting section 322 transmits accounting information containing the processing content information stored in the accounting information DB 320 to the charging server 4 (S220).

When the printer 16 fails in a printing of the bitmap data received from the image processing server 3 (first RIP/color correcting program 30; FIG. 3), this printer 16 notifies a failure of this printing to the image processing server 3 (S140).

The image processing server 3 outputs to the charging server (charging program 40; FIG. 4) accounting information, which includes status information containing success processing information (status information) indicating that the RIP/color correcting processing succeeded and the printing processing has failed (S240).

The image processing server 3 notifies this failure of the printing to the client PC 12 (S144).

Upon receipt of this accounting information, the fee changing section 410 of the charging server 4 discounts a fee, which has been calculated by the fee calculating section 408 and has been stored in the accounting DB 412. The charging processing section 414 charges the user of the client PC 12 with discount (S146).

As described above, since the image processing server 3 changes the content of the accounting information in a proper manner, a timing of transmitting the accounting information from the image processing server 3 to the charging server 4 can be changed.

[Normal Sequence 3]

A description will be made on provisional charging processing in which the fee calculating section 408 of the charging program 40 (FIG. 4) operating on the image processing server 4 (FIGS. 1 and 2) registers a provisional accounting amount in the accounting DB 412.

As shown in FIGS. 10 and 11, this provisional charging process is applied to the print system 1 in a case where the image processing server 3 transmits the processing content information to the charging server upon receiving the print job 4 and transmits the accounting information containing the status information upon receiving a result of the printing processing.

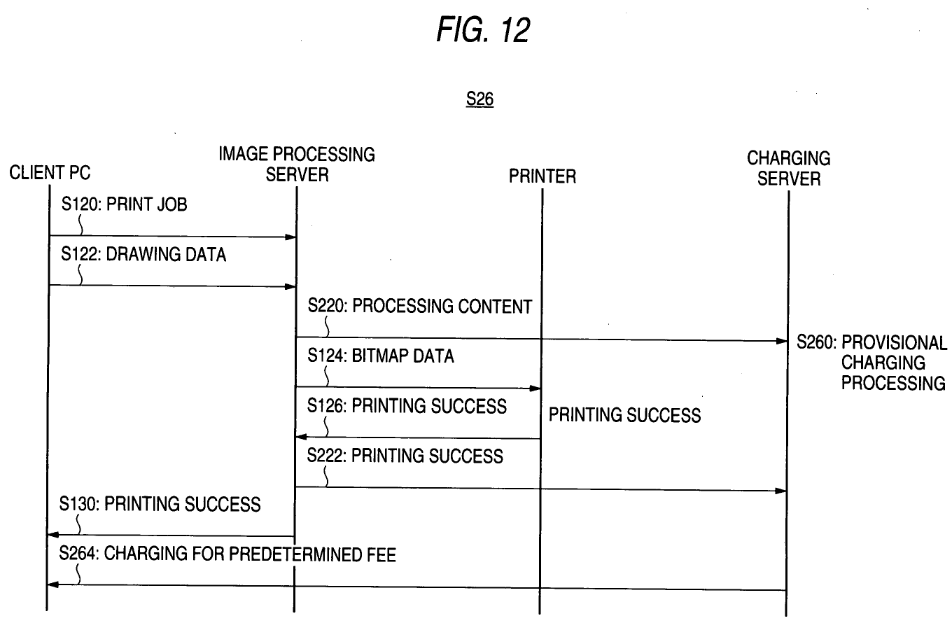

FIG. 12 is a diagram for showing a third normal sequence (S26) of the print system 1 (FIG. 1).

It should be noted that the same reference numerals shown in the sequence of FIGS. 6 and 10 will be employed as those for denoting essentially same sequence shown in FIG. 12.

As shown in FIG. 12, the client PC 12 designates content of a print job, and transmits drawing data to be processed (S120 and S122).

The UI section 308 of the RIP/color correcting program 30 generates the processing content information indicating the content of this print job and then, stores this processing content information in the accounting information DB 320.

The accounting information transmitting section 322 outputs the accounting information containing the processing content information stored in the accounting information DB 320 to the charging server 4 (S220).

The fee calculating section 408 of the charging program 40 (FIG. 4) calculates a predetermined for a case where the print job is ended normally at this stage, and then, provisionally stores (registers) the calculated fee as a provisional accounting amount in the accounting DB 412 (S260).

The image processing server 3 processes the drawing data in accordance with the process content designated by the client PC 21 to generate bitmap data, designates a printing method, and outputs the generated bitmap data and the designated printing method to the printer 16 (S124).

The printer 16 prints the bitmap data supplied from the image processing server 3. When the printing operation is ended normally, this printer 16 notifies success of the printing to the image processing server 3 (S126).

The image processing server 3 outputs accounting information to the charging server 3 (charging program 40; FIG. 4) (S222). This accounting information includes the processing content information and execution time information (status information) indicating that the printing succeeded and the processing to be charged is a first processing.

The image processing server 3 notifies the success of the printing to the client PC 12 (S130).

Upon receipt of this accounting information, the fee changing section 410 of the charging program 40 (FIG. 4) determines as a determined accounting amount, the predetermined account, which has been provisionally registered in the accounting DB 412 at S260.

The charging processing section 414 charges the user of the client PC 12 for the determined predetermined accounting amount. (S262).

[Print Failure Sequence 4]

Next, a description will be made on an operation in which the printer 16 has failed in a printing when the accounting server executes a provisional accounting processing.

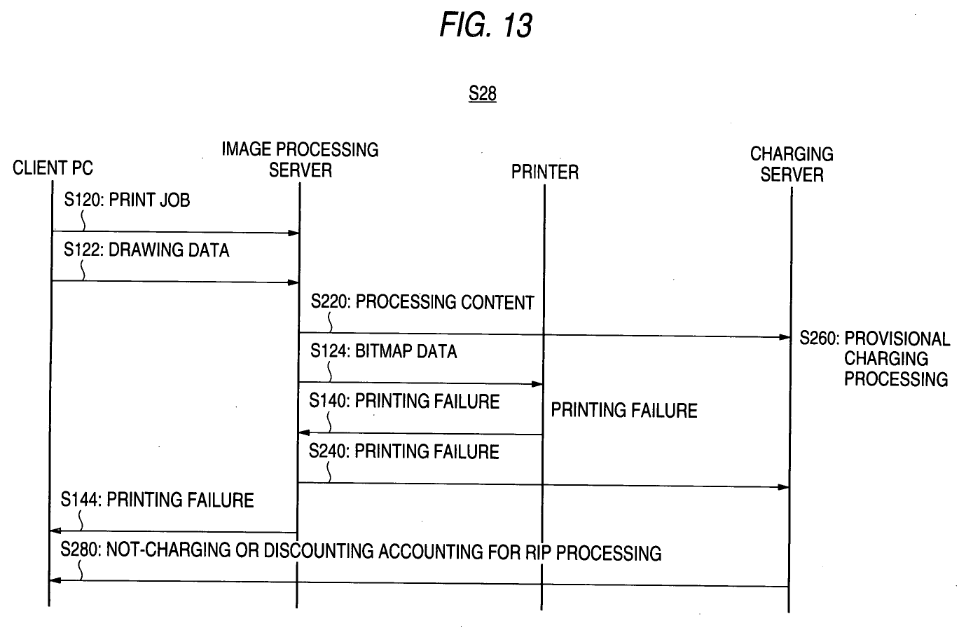

FIG. 13 is a sequence diagram for showing a fourth operation (S28) at a time of printing failure in the print system 1 (FIG. 1).

It should be noted that the same reference numerals shown in the sequence of FIGS. 6 and 10 to 12 will be employed as those for denoting essentially same sequence shown in FIG. 13.

As shown in FIG. 13, the client PC 12 designates content of a print job, and transmits drawing data to be processed (S120 and S122).

The UI section 308 of the RIP/color correcting program 30 generates processing content information indicating the contents of this print job and then, stores this processing content information in the accounting information DB 320.

The accounting information transmitting section 322 outputs accounting information containing the processing content information stored in the accounting information DB 320 to the charging server 4 (S220).

The fee calculating section 408 of the charging program 40 (FIG. 4) calculates a predetermined fee for a case where the print job is ended normally at this stage, and then, provisionally stores (registers) the calculated fee as a provisional accounting amount in the accounting DB 412 (S260).

The image processing server 3 processes the drawing data in accordance with the process content designated by the client PC 12 to generate bitmap data, designates a printing method, and outputs the generated bitmap data and the designated printing method to the printer 16 (S124).

The printer 16 prints the bitmap data supplied from the image processing server 3.

When the printing by the printer 16 has failed, the printer 16 notifies this failure of the printing to the image processing server 3 (S140).

The image processing server 3 outputs the accounting information to the charging server 4 (charging program 40; FIG. 4) (S240). This accounting information includes success processing information (status information) indicating that the RIP/color correcting processing succeeded but the printing processing has failed.

The image processing server 3 notifies this failure of the printing to the client PC 12 (S144).

Upon receipt of this accounting information, the fee changing section 410 of the charging server 4 discounts the provisional accounting amount, which has been stored in the accounting DB 412, and also, sets the discounted accounting amount as a determined accounting amount.

The charge processing section 414 charges the user of the client PC 12 for the discounted accounting amount (S280) Basically, charging processing is executed independently from the RIP processing and the printing processing. However, the print job instructed from the client PC 12 is managed as a single print job. Therefore, if the entire designated print jobs is not completed, the accounting amount is not determined.

At this stage, accounting information, which is recorded when the entire print job has not yet been completed but only the RIP processing contained therein completed, is not determined. That is, the accounting information is undetermined. Therefore, a charging processing with using the undefined accounting information is not executed.

If a provisional charging processing is executed on the basis of the undetermined accounting information at this stage, the charging processing can be executed by merely changing the accounting information from the undetermined state to the determined state when the print job is ended.

Accordingly, the actual charging processing is not executed at a time of executing the provisional accounting. However, since the records of the provisional charging processing is left, fair charging processing can be realized with respect to the users. Also, it becomes possible to record/manage the provisional accounting amounts.

[Third Embodiment]

A third embodiment of the invention will now be described.

[Second Print System 2]

First, a second print system 2 is described.

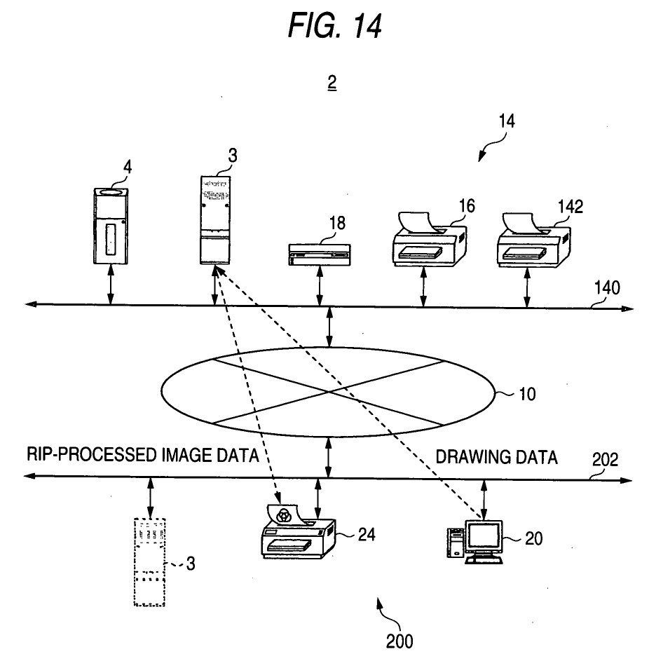

FIG. 14 is a diagram for showing an example of a configuration of the second print system 2 to which the image processing method according to the invention is applied.

It should be noted that the same reference numerals shown in FIG. 1 will be employed as those for denoting the essentially same structural components shown in FIG. 14.

As shown in FIG. 14, in the second print system 2, the client PC 12 of the first print system 1 shown in FIG. 1 is replaced with a LAN system 200.

This LAN system 200 includes a client PC 20 similar to the client PC 12 and a printer 16 similar to the printer 24, which are connected to each other through a LAN 202.

As indicated by an arrow of a dotted line in FIG. 14, in the second print system 2, the client PC 20 requests an RIP processing and a color correcting processing to the image processing server 3, and then, the printer 24 prints image data obtained as a result of these processing.

[Outline of Process]

Next, a description will now be made on an outline of processings by the second print system 2 of the third embodiment.

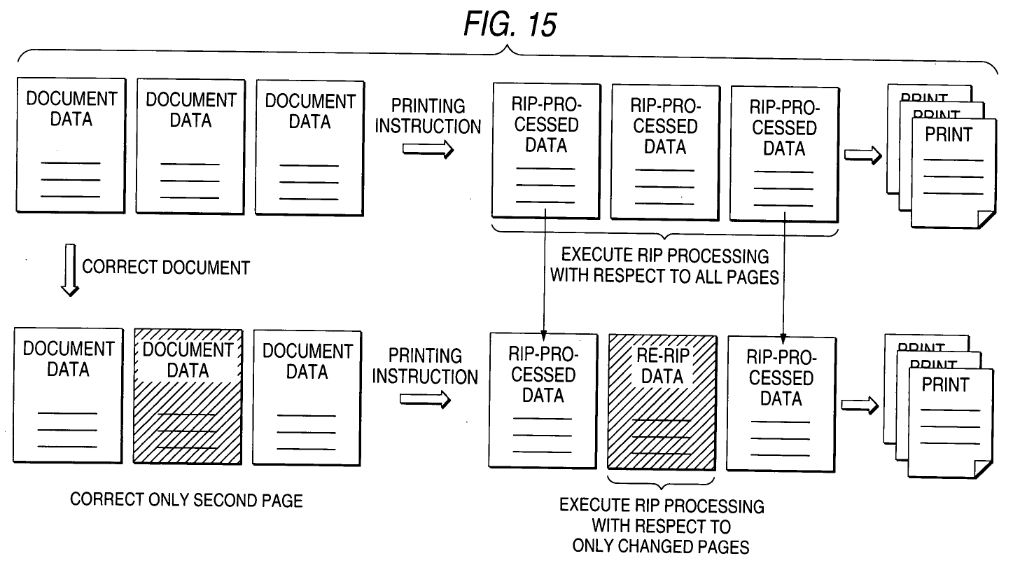

FIG. 15 is a first diagram for showing an outline of an RIP processing executed in the second print system 2 shown in FIG. 14.

For example, the following case is assumed. The image data is document data having 3 pages (shown in an upper left portion of FIG. 15). After the RIP processing and the color correcting processing are executed with respect to the document data, the document data is further edited to correct two page of the document data (see a lower left portion of FIG. 15).

Hereinafter, an example in which a target of the RIP processing is document data will be described. Also, the RIP processing and the color correcting processing will be also, simply referred to as an “RIP processing”.

In this case, if the document data is merely and again RIP-processed and printed without considering the corrected portion, it is necessary to execute the RIP processing with respect to the entire document data having three pages as shown in an upper middle portion of FIG. 15.

In other words, in this case, an accounting for the RIP processing with respect to the entire pages of the document is required in spite of correcting a part of the document.

To the contrary, when a corrected portion is taken into consideration as shown in a lower middle portion of FIG. 15 and only the corrected pages are again RIP-processed and printed, only necessary minimum fee will be required.

The third embodiment of the invention has been made in view of these points. That is, when image data, which have already been subjected to the RIP processing and the color correcting processing, is furthermore corrected/changed, only a portion of image data, which is corrected/changed, is again RIP-processed. As a result, requirement of a fee is suppressed to minimum extent.

[(3-1) Re-Rip Processing for Each Corrected Portion]

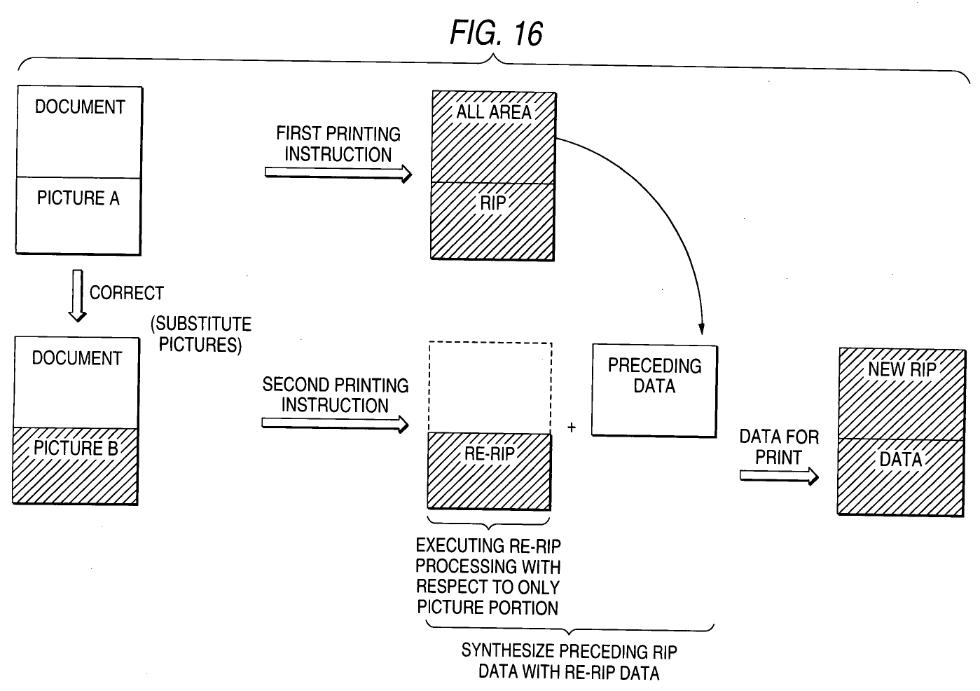

FIG. 16 is a second diagram for showing an outline of an RIP processing executed in the second print system 2 shown in FIG. 14.

As shown in an upper left portion and an upper middle portion of FIG. 16, for instance, document data contains a document and a picture A in the beginning. The entire document data is RIP-processed, when a first print instruction is issued.

As shown in a lower left portion of FIG. 16, for example, when after this first RIP processing is executed, the document of this document data is not changed but only a change is made to substitute the picture A with another picture B, the RIP processing (referred to as “re-RIP processing”) is not executed with respect to the document, which has already been subjected to the RIP processing but the RIP processing is executed with respect to the changed picture B. Then, image data of the document obtained form the first RIP processing and image data of the picture B obtained from the re-RIP processing are synthesized.

With this method, as shown in a right side of FIG. 16, when only the re-RIP processing is executed with respect to a part of the corrected document data, we can obtain the same effect as a case where the RIP processing is executed with respect to the entire document data. Furthermore, time, machine power, fee, which are required to execute the RIP processing, can be kept to minimum.

In this case, an accounting amount for a document of 0.5 page may be calculated as an accounting amount for the RIP processing with respect to image data less than 1 page.

[(3-2) Re-Rip Process for Each Page]

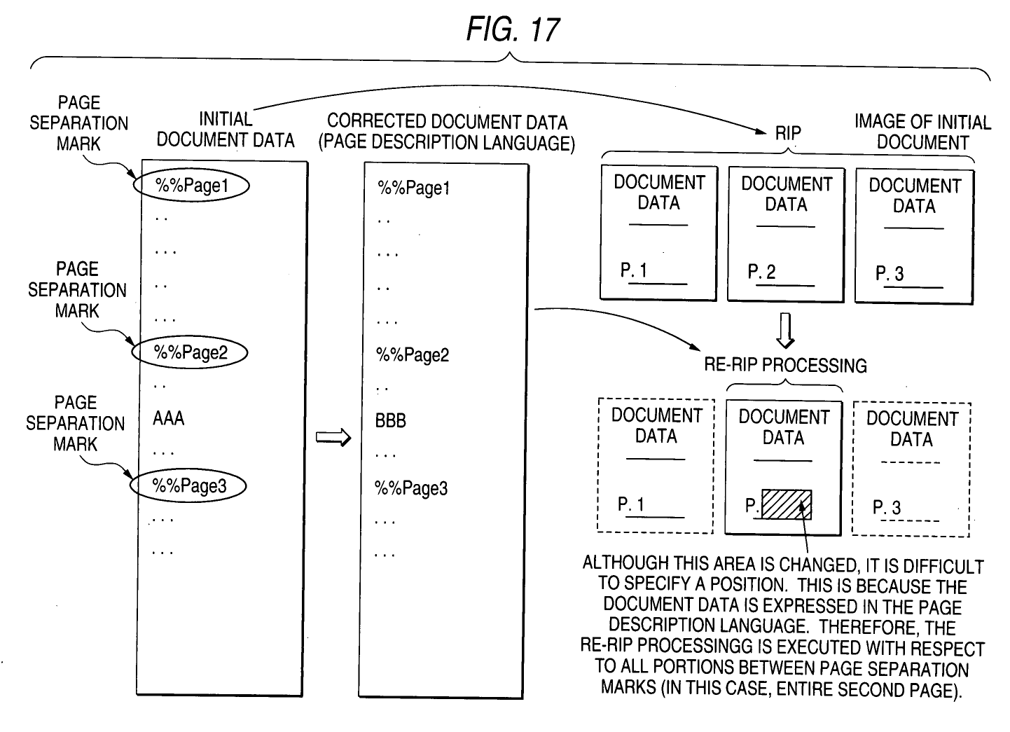

FIG. 17 is a third diagram for showing an outline of an RIP processing executed in the second print system 2 shown in FIG. 14.

For example, when image data is document data, which is described in a drawing language, as shown in FIG. 16, it is difficult to handle a portion contained in a single page as a unit of correcting/extracting. However, it is easy to handle a single page as a unit of correcting/extracting.

For instance, after RIP-processed image data (shown in an upper right portion of FIG. 17) is obtained by a first RIP processing, of document data of three pages described in the drawing data, a character string “AAA” in page 2 is corrected to another character string “BBB” as shown in a left side of FIG. 17.

In this case, for example, as shown in the lower right portion of FIG. 17, only a page number of a second page is changed. However, since the document page to be subjected to the RIP processing is described in the page drawing language, it cannot be judged where a portion of the page number is in an image of second page before executing the RIP processing.

Accordingly, in this case, correction is detected in the page unit and the RIP processing is again executed with respect to only a page containing the corrected portion. Thereby, time and fee required to execute the RIP processing can be reduced.

[(3-3) Re-Rip Process for Each Paper]

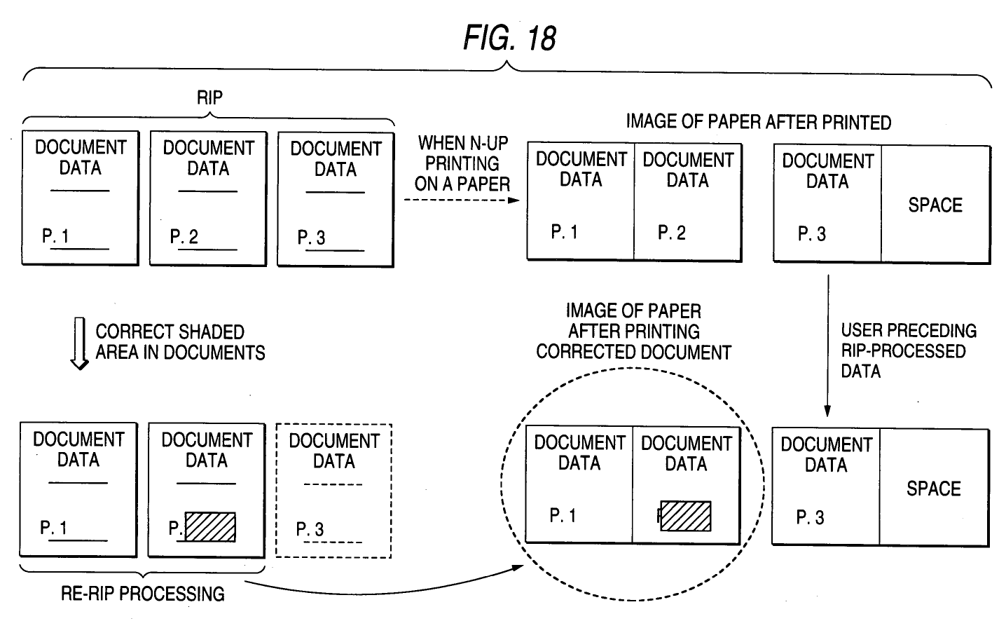

FIG. 18 is a fourth diagram for showing an outline of an RIP processing performed in the second print system 2 shown in FIG. 14.

Printing image data of N pages on a single sheet of paper is called an N-up printing.

For example, when document data of three pages as shown in an upper left portion of FIG. 18 is subjected to the RIP processing for 2-up printing, we can obtain image data shown in an upper right portion of FIG. 18.

As described above, consider that after the RIP processing for 2-up printing has already been executed, a portion of page number in a second page is corrected as shown in a lower left portion of FIG. 18.

In this case, it is necessary to execute the RIP processing with respect to not only the corrected second page of the document data, but also the first page of the document data, which is printed on the same paper.

Accordingly, as shown in a lower right portion of FIG. 18, when the correction is made on the document data, which is obtained by way of the RIP processing for N-up printing, it is necessary to detect the correction not in a page unit, but in a sheet unit and to execute the RIP processing again.

As described above, the document data (the first and second pages of the document data), which is subjected to the RIP processing in the sheet unit again and is to be printed on a first sheet of paper is synthesized with the third page of RIP-processed document data, which contains no correction and is not changed after being obtained from the first RIP processing. Thereby, time and fee, which are required to execute the RIP processing, can be saved.

[(3-4-1) First Re-Rip Processing for all Portions Following Corrected Portion]

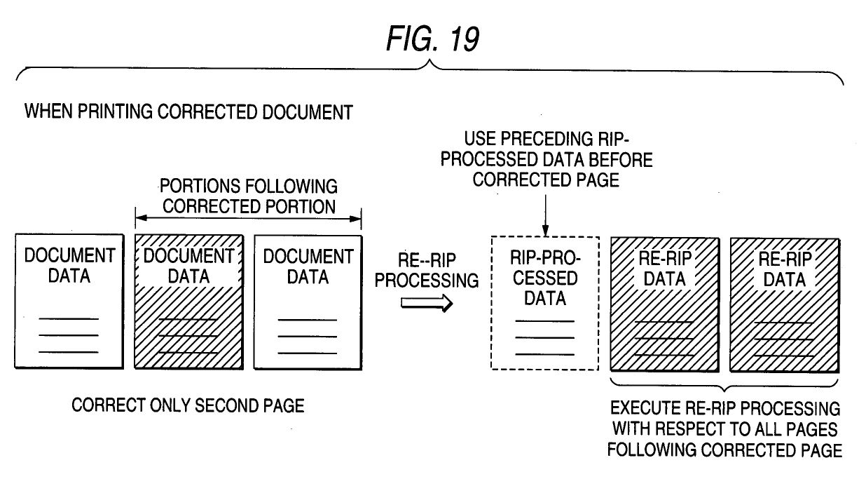

FIG. 19 is a fifth diagram for showing an outline of an RIP processing executed in the second print system 2 shown in FIG. 14.

As shown in FIG. 19, for example, when a correction is made to add a sentence to a second page of document data having three pages, which have already been RIP-processed, a total line number may be increased. As a result, there is a possibility that not only a page layout of the second page, but also a page layout of the third page are changed.

In other words, a correction to a certain document portion may give an influence on all portions following the corrected page.

In this case, as shown in FIG. 19, it is necessary to execute the re-RIP processing with respect to all portions following the corrected page.

[(3-4-2) Second Re-Rip Processing for All Portions following Corrected Portion]

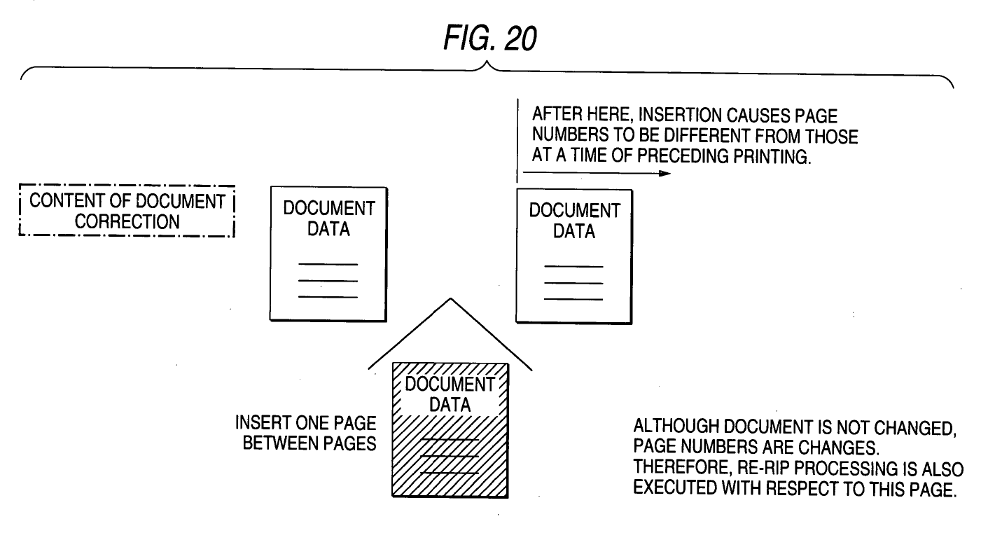

FIG. 20 is a diagram for showing a processing for inserting a page into document data.

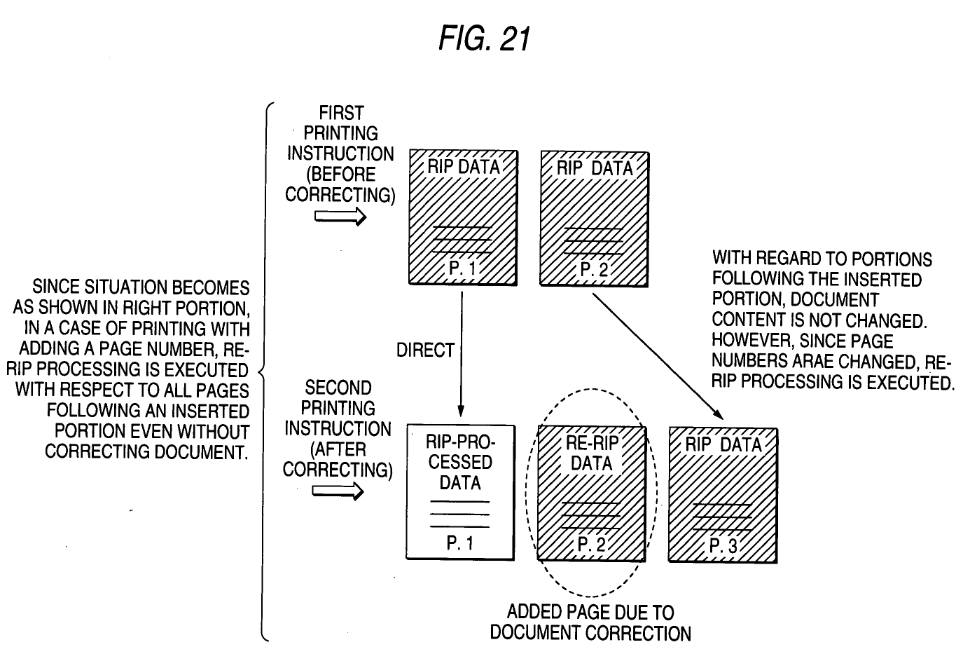

FIG. 21 is a sixth diagram for showing an outline of an RIP processing executed in the second print system 2 shown in FIG. 14.

For example, as shown in FIG. 20, a new page might be added between two pages of document data, which have already been RIP-processed.

In such a case, a page number of the page, which was so far the second page, is counted up, so that this page number is changed from “page 2” to “page 3.”

As a result, as shown in FIG. 21, when the new page is inserted into the document data, which have already been RIP-processed, it is necessary to execute the re-RIP processing with respect to the new page of the document data and the pages of the document data subsequent to this new page.

It should be noted that when only the page numbers are merely changed due to the execution of the re-RIP processing, it is preferable as a service for a customer to make fee for the re-RIP processing be free or to discount the fee.

[Second Rip/Color Correcting Program 34]

Next, a description will now be made on a second RIP/color correcting program 34, which realizes the re-RIP processing described above.

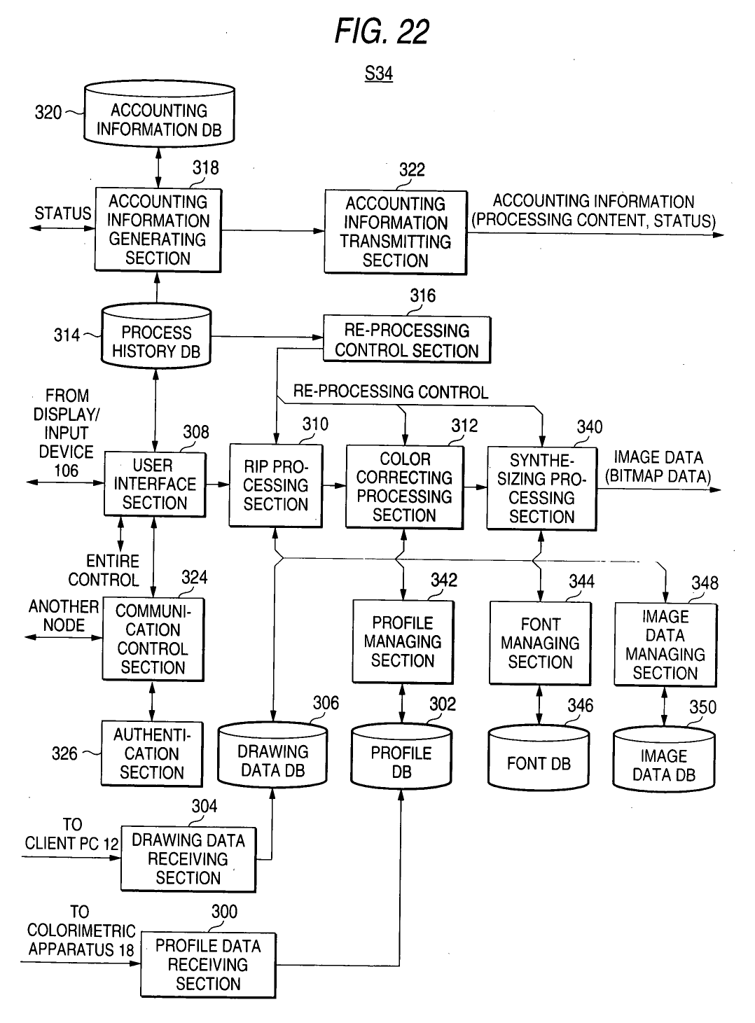

FIG. 22 is a schematic diagram for showing a configuration of the second RIP/color correcting program 34, which is operated on the image processing server 3 (FIG. 14) to execute the re-RIP processing shown in FIGS. 15 to 21.

It should also be noted that the reference numerals shown in the structural components of the first RIP/color correcting program 30 shown in FIG. 3 will be employed as those for denoting the essentially same structural components of the second RIP/color correcting program 34 shown in FIG. 22.

In order to make description clear and specific, a case is taken as an example in which drawing data described in a drawing language is transmitted from the client PC 20 to the image processing server 3.

As shown in FIG. 22, the second RIP/color correcting program 34 employs a configuration in which a synthesizing processing section 340, a profile managing section 342, a font managing section 344, a font DB 346, an image data managing section 348, and an image data DB 350 are added to the first RIP/color correcting program 30.

It should be understood that the profile managing section 342, the font managing section 344, and the font DB 346 are structural components required for executing the RIP processing and the color correcting processing. Furthermore, these structural components are regarded that the first RIP/color correcting program 30 shown in FIG. 3 contains and thus are omitted, but are explicitly shown in FIG. 22.

In the second RIP/color correcting program 34, the re-processing control section 316 controls the re-RIP processing shown in FIGS. 15 to 21 in addition to the control of the described processes for reusing the RIP-processed image data.

The profile DB 302 stores thereinto profile data such as the TP data, the DLP data, and the DP data, which are supplied from the network 10 or the recording medium 114 (FIGS. 1 and 2) and are required to execute the color correcting processing in the color correcting processing section 312.

The profile managing section 342 manages the profile data stored in the profile DB 302, and properly provides the managed profile data to the color correcting processing section 312 for the color correcting processing.

The font DB 346 stores thereinto font data, which is supplied from the network 10 or the recording medium 114 (FIGS. 1 and 2), and is used in a processing for expanding the drawing data in the RIP processing section 310.

The font managing section 344 manages the font data stored in the font DB 346 and supplied the managed font data to execute the RIP processing in the RIP processing section 310.

The image data DB 350 stores thereinto the image data, which has been RIP-processed by the RIP processing section 310, the image data, which has been color-corrected by the color correcting processing section 312, and the image data, which has been synthesized by the synthesizing processing section 340.

The image data managing section 348 manages the image data stored in the image data DB 350, and provides the stored image data to execute the image synthesizing processing in the synthesizing processing section 340.

As shown in FIGS. 15 to 21, the synthesizing processing section 340 synthesizes image data, which has not been subjected to the re-RIP processing, with image data, which has been subjected to the re-RIP processing. When the re-RIP process is executed in the page unit/sheet unit, the synthesizing processing section 340 controls the printer 24 to execute a so-called merge printing so that a similar effect to that achieved when the image data are actually synthesized with each other may be achieved. In this merge printing, in the middle of printing certain image data, another image data is printed.

[Second Image Processing Program 22]

Next, a second image processing program 22 will now be described, which is operated on the client PC 20 to realize the re-RIP processing shown in FIGS. 15 to 21.

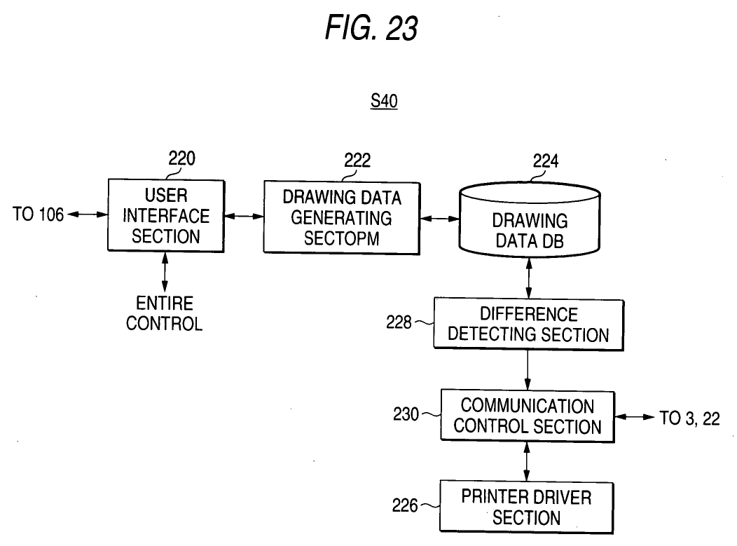

FIG. 23 is a schematic diagram for showing a configuration of the second image processing program 22, which is operated on the client PC 20 (FIG. 14) to execute the re-RIP processing shown in FIGS. 15 to 21.

As shown in FIG. 23, the image processing program 22 includes a UI section 220, a drawing data generating section 222, an image data DB 224, a difference detecting section 228, a communication control section 230, and a printer driver section 226.

The second image processing program 22 generates drawing data using these structural components to request the image processing server 3 to execute the RIP processing and the color correcting processing. Then, the second image processing program 22 outputs the generated drawing data to the image processing server 3.

Also, when the drawing data, which has already requested the image processing server 3 to execute the RIP processing, the color correcting processing, and the printing processing, is corrected thereafter, the second image processing program 22 detects a corrected portion in the drawing data and requests the image processing server 3 (RIP/color correcting program 34; FIG. 22) to execute a re-RIP processing.

The UI section 220 accepts an operation by a user with respect to the input/display apparatus 106 (FIG. 2), and controls operations of the respective structural components of the second image processing program 22 in accordance with the accepted user's operation.

The drawing data generating section 222 describes drawing data in a page drawing language in accordance with the operation of the user input via the UI section 220, and then stores this drawing data in the image data DB 224.

The difference detecting section 228 detects a difference such as a correction made with respect to the drawing data, in accordance with control of the UI section 220.

When the difference detecting section 228 detects the difference, the difference detecting section 228 requests the image processing server 3 to execute the re-RIP processing as shown in FIGS. 15 to 21 with taking the difference occurred in the drawing data into consideration.

The communication control section 230 realizes a communication sequence (not shown) between the image processing program 22 and other nodes in the same manner as the communication control section 324 of the RIP/color correcting program 34 executes.

With regard to the image data (drawing data), which does not requires to be subjected to the RIP processing/color correcting processing, the printer driver section 226 controls the printer 24 to print the image data (drawing data).

With regard to the image data (drawing data), which requires to be subjected to the RIP processing/color correcting processing, the printer driver section 226 causes the server to execute a data processing. Therefore, the printer driver section 226 does not operate.

[Third Image Processing Program 26]

Next, a third image processing program 26 will now be explained, which is operated on the printer 24 to realize the re-RIP processing shown in FIGS. 15 to 21.

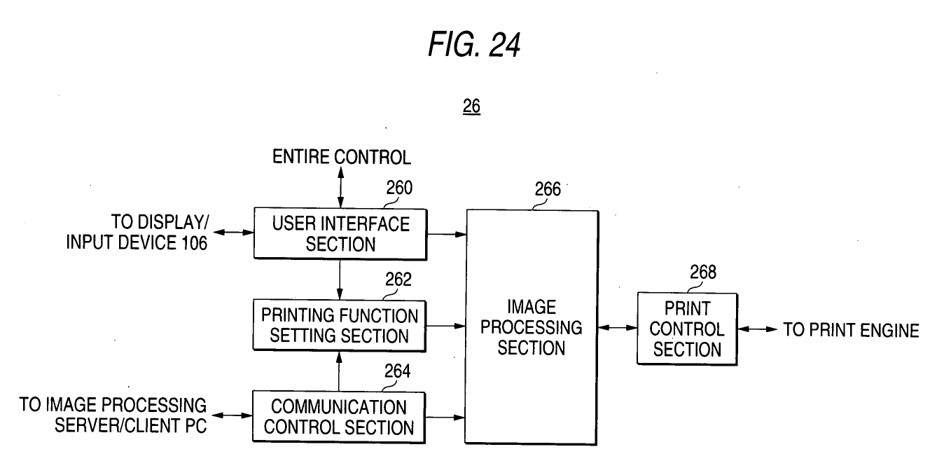

FIG. 24 is a schematic diagram for showing a configuration of the third image processing program 26, which is operated on the printer 24 (FIG. 14) to execute the re-RIP processing shown in FIGS. 15 to 21.

As shown in FIG. 24, the third image processing program 26 includes a UI section 260, a printing function setting section 262, a communication control section 264, an image processing section 266, and a print control section 268.

In the third image processing program 26, the UI section 260 accepts an operation of a user with respect to the input/display apparatus 106, and controls operations of the respective structural components of the third image processing program 26.

The printing function setting section 262 sets a printing function in the printer 24 in response to the operation of the user input via the UI section 260.

The communication control section 264 controls a communication with respect to other nodes to realize a communication sequence (not shown).

The image processing section 266 expands image data input from the communication control section 264 to bitmap data in accordance with the function set by the printing function setting section 262. Then, the image processing section 266 outputs the expanded bitmap data to the print control section 268.

The print control section 268 controls a print engine (function realizing unit 108; FIG. 2) of the printer 24 to print the bitmap data generated by the image processing section 266.

[Operation of Print System 2]

An operation of the print system 2 will now be explained.

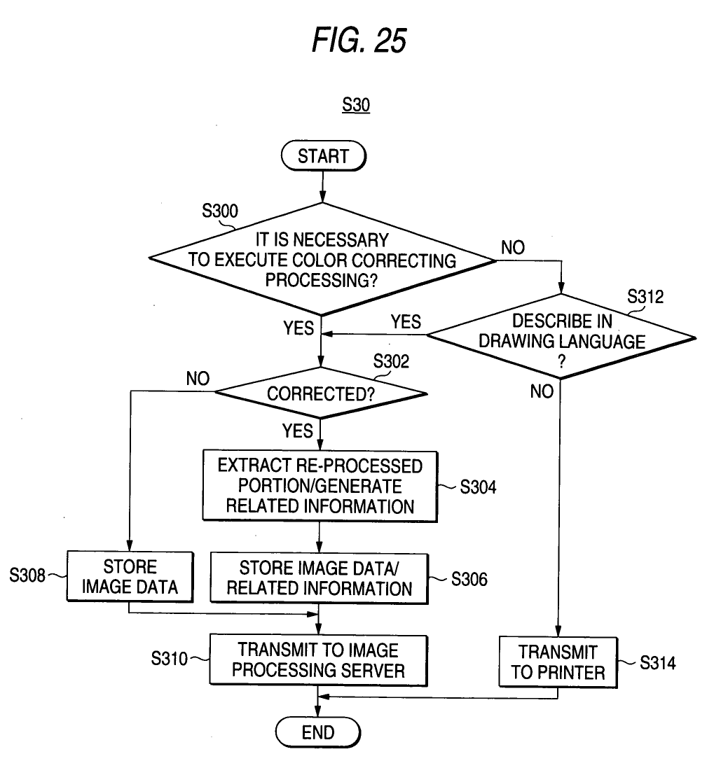

FIG. 25 is a flow chart for showing a processing (S30) executed on the side of the client PC 20 (image processing program 22) in the print system 2 (FIG. 14).

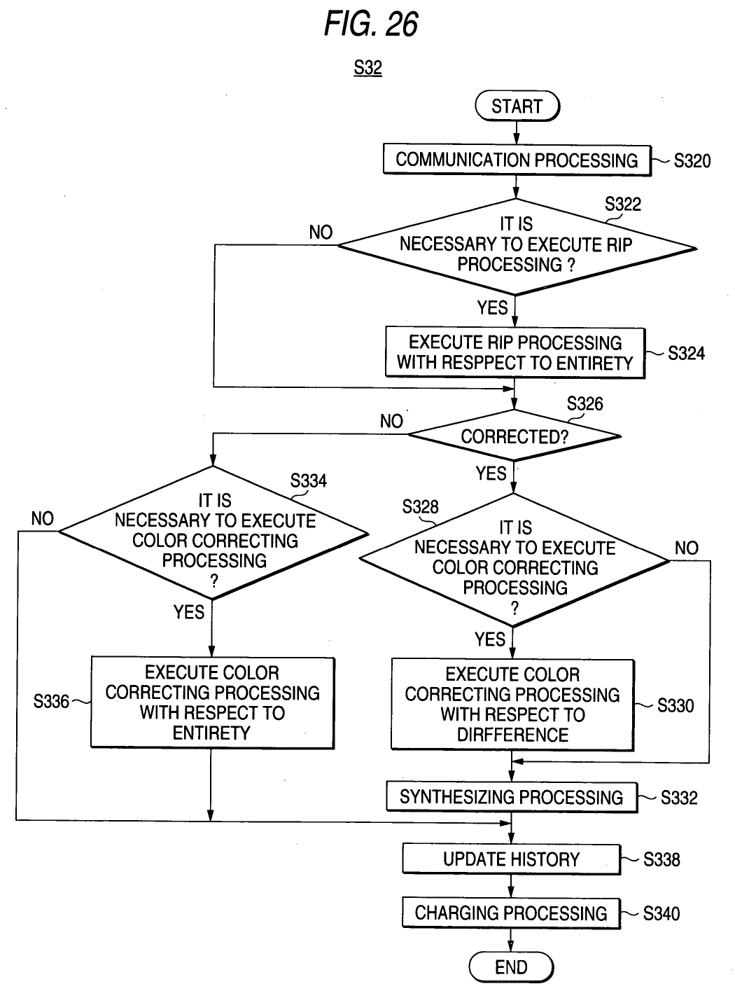

FIG. 26 is a flow chart for showing a first processing (S32) executed on the side of the image processing server 3 (RIP/color correcting program 34) in the print system 2 (FIG. 14).

First of all, a description is made on a case in which a partial RIP processing is not executed.

As shown in FIG. 25, the UI section 220 judges as to whether or not a color correcting processing is required with respect to image data (drawing data), which is to be printed by the printer 24, in a step 300 (S300).

When the color correcting processing is required, the process of the image processing program 22 is advanced to a process of a step S302, whereas in other cases than the above-explained case, the process of the image processing program 22 is advanced to a process of a step 312 (S312).

Further, in the step S312, when it is so judged that a processing executed on the server 3 side with respect to the image data (drawing data) is not required, the printer driver 226 shown in FIG. 23 is initiated and the image data (drawing data) is sent to the printer 24.

In other cases than the above-described case, the processing with respect to the image data is executed in the process of the step S302.

In the step 302 (S302), the difference detecting section 228 judges as to whether or not the image data (drawing data), which is a target of the judgment of the step S300, is corrected after the preceding RIP processing has been accomplished.

When no correction is made in the image data, the image processing program 22 judges that any correction/change are not made after the image data (drawing data) has been firstly processed by the RIP processing, or after the image data (drawing data) was RIP-processed in the preceding processing. Then, the process of this image processing program 22 is advanced to a process of a step S308. Whereas, in other cases than the above-described case, the process of this image processing program 22 is advanced to another process of a step S304.

The image processing program 22 extracts a changed portion (namely, portion required to be re-processed) over the preceding process and then, adds information indicating this changed portion to the stored preceding image data (drawing data), in the process of the step S306. Thereafter, the process of this image processing program 22 is advanced to a process of a step S310.

As described above, when the entire new drawing data is not stored but only the difference over the preceding drawing data is added, the storage area such as a hard disk can be saved.

In the process of the step S310, the image processing program 22 transmits the entire drawing data to the image processing server 3 shown in FIG. 14.

Furthermore, when the difference information over the preceding drawing data is present, the image processing program 22 transmits this difference information to the image processing server 3 together with the entire drawing data.

In the latter case, the server 3 analyzes the difference information.

When the client PC 20 not only extracts the difference information, but also analyzes the difference information, the traffics of the LAN 20 are decreased. However, generally speaking, it is preferable that the image processing server 3 executes an analyzing processing for judging how far the difference may give the influence.

A first reason is that since the interpreting function of the page description language is provided only on the server 3 side in the print system, it is so natural that the analyzing process is performed on the server 3 side.

A second reason is that since the load of the analyzing process is heavy, if this analyzing process is performed by the image processing server 3 having the higher processing capability than that of the client PC 20, there is a merit in view of the processing speed.

In the step 304 (S304), the difference detecting section 228 extracts a portion of image data (drawing data), which requires the re-RIP processing and the color correcting processing in the image processing server 3.

This portion of the image data (drawing data) is influenced by the change/correction of the image data (drawing data) based on the difference information, which is transmitted from the client PC 20 together with the image data (drawing data).

Further, the difference detecting section 228 generation related information indicating an identifier (image ID) of the image data, a portion where the correction is detected, and the profile data required in the re-RIP processing.

In the step 306 (S306), the difference detecting section 228 stores the image data (drawing data) in the image data DB 224 as image data (drawing data) to be transmitted to the image processing server 3, while the related information is attached to this image data (drawing data).

In a step 308 (S308), the difference detecting section 228 stores images data (drawing data) from which the correction is not detected in the image data DB 224 as image data (drawing data) to be transmitted to the image processing server 3.

In a step 310 (S310), the communication control section 230 reads the image data from the image data DB 224 via the difference detecting section 228, and transmits the read image data to the image processing server 3.

In a step 312 (S312), the difference detecting section 228 judges as to whether or not the image data (drawing data), which is a target of the judgment of the step S300, is drawing data described in the drawing language.

When the image data is the drawing data described in the drawing language, the process of the image processing program 22 is advanced to the process of the step S302, whereas in other cases than the above-explained case, the image processing program 22 judges that the RIP processing is required and the process is advanced to a process of a step S314.

In this step 314, the communication control section 230 outputs the image data to the printer 24.

Also, as shown in FIG. 26, on the side of the image processing server 3, in a step 320 (S320), the communication control section 324 performs a communication processing, and receives image data (drawing data) from the image processing program 22.

In a step 322 (S322), the UI section 308 judges as to whether or not the received image data (drawing data) requires to be RIP-processed.

When the received image data is the drawing data and requires to be RIP-processed, the process of the RIP/color correcting program 34 is advanced to a process of a step S324. Whereas, in other cases than the above-described case, the process is advanced to another process of a step S326.

In the step 324 (S324), the RIP processing section 310 executes the RIP processing with respect to the entire drawing data to obtain image data.

In the step 326 (S326), the re-processing control section 316 judges as to whether or not the image data includes a corrected portion.

When the image data includes the corrected portion, the process of the RIP/color correcting program 34 is advanced to a process of a step S328. Whereas in other cases than the above-described case, the process thereof is advanced to a process of a step S334.

In the step 328 (S328), the re-processing control section 316 judges as to whether or not a color correction is required for the image data.

When the color correction is required for the image data, the process of the RIP/color correcting program 34 is advanced to the process of the step S300. Whereas, in other cases than the above-described case, the process thereof is advanced to a process of a step S332.

In the step 330 (S330), the color correcting processing section 312 executes the color correcting processing with respect to an portion (difference) of the image data where the correction/change have been made.

In the step 332 (S332), the synthesizing processing section 340 reads a portion, which has not been corrected/changed, of the color-corrected image data stored in the image data DB 350. Then the synthesizing processing section 340 synthesizes the read portion with the difference, which has been processed by the color correcting processing in the step S330.

In a step 334 (S334), the re-processing control section 316 judges as to whether or not a color correction is required for the image data.

When the color correction is required for the image data, the process of the RIP/color correcting program 34 is advanced to a process defined a step S336. Whereas, in other cases than the above-described case, the process thereof is advanced to a process of a step S338.

In the step 336 (S336), the color correcting processing section 312 executes the color correcting processing with respect to the entire image data.

In the step 338 (S338), the re-processing control section 316 stores the above-described processings in a process history DB to update a processing log.

In a step 340 (S340), the image processing server 318 transmits accounting information to the charging server 4 with reference to the updated processing log.

The charging server 4 charges the client PC 20 in accordance with the accounting information transmitted from the image processing server 3.

At this time, it should be noted that in accordance with the setting, the charging server 4 charges for the profile data and the font data, which have been used, as well as the image processing.

Next, a description will now be made on a case in which a partial RIP processing is executed.

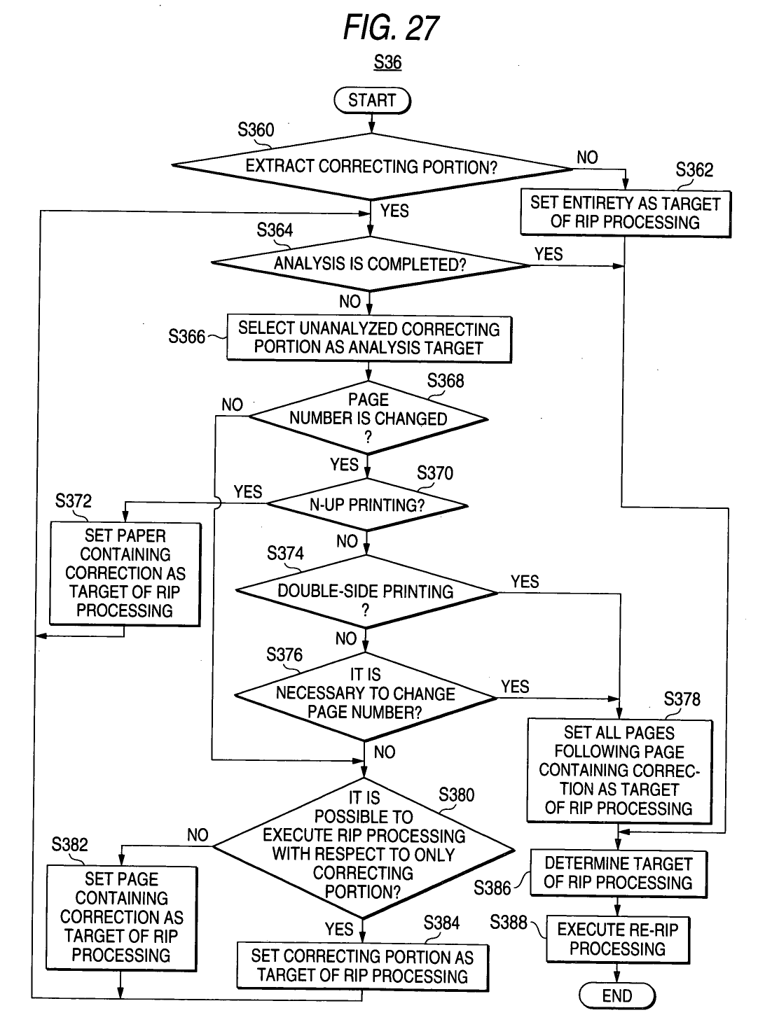

FIG. 27 is a flow chart for showing a second processing and subsequent processings (partial RIP processing; S36) on the image processing server 3 (RIP/color correcting program 34) side when the RIP processing is executed partially in the print system 2 (FIG. 14).

It should be understood that of each processing shown in FIG. 26, RIP-processing portions are changed to the re-RIP processing shown in FIG. 27.

Although the processings except for the re-RIP processing are omitted from the flow chart of FIG. 27, each of these omitted processings are similar to each of processings shown in FIG. 26.

As shown in FIG. 27, in a step 360 (S360), the re-processing control section 316 extracts a portion, which requires to be corrected, from image data (drawing data) transmitted from the client PC 20.

When the correcting portion can be extracted from the image data (drawing data), the process of the RIP/color correcting program 34 is advanced to a process of a step S364. Whereas, in other cases than the above-described case, the process of this program 34 is advanced to another process of a step S362.

It should also be noted in this example that the re-processing control section 316 detects the correcting portion based on the related information, which has been attached to the image data (drawing data) on the side of the client PC 20. Alternatively, the re-processing control section 316 may read image data (drawing data) having the same image ID as that of newly-received image data (drawing data) from the image data DB 350 and then, may compare the newly-received image data (drawing data) with the image data (drawing data) read form the image data DB 350 to extract the correcting portion.

It should also be noted that in order to extract this correcting portion, various methods may be employed, for example, an application of the process, which is known as “diff” in UNIX (registered trademark), and a method of comparing either page numbers or versions of these image data (drawing data).

In a step 362 (S362), the re-processing control section 316 determines that the entire image data (drawing data) should be processed by way of the re-RIP processing.

In a step 364 (S364), the re-processing control section 316 judges as to whether or not it is finished to analyze the entire image data (drawing data).

When the analysis for the entire image data (drawing data) is completed, the process of the RIP/color correcting program 34 is advanced to a process of a step S386. Whereas, in other cases than the above-described case, the process thereof is advanced to another process of a step S366.

In the step 366 (S366), the re-processing control section 316 selects a correcting portion, which has not yet been analyzed as an analysis target.

In a step 368 (S368), the re-processing control section 316 judges as to whether or not the page number of the image data (drawing data) is changed.

When the page number is changed, the process of the RIP/color correcting program 34 is advanced to a process of a step S370. Whereas in other cases than the above-described step, the process thereof is advanced to another process of a step S380.

In the step 370 (S370), the re-processing control section 316 judges as to whether or not the image data (drawing data) is N-up printed.

When the image data (drawing data) is N-up printed (see FIG. 18), the process of the RIP/color correcting program 34 is advanced to a process of a step S374. Whereas, in other cases than the above-described step, the process thereof is advanced to another process of a step S372.

In the step 372 (S372), the re-processing control section 316 determines a paper containing a correction as a target, which should be processed in the re-RIP processing.

In the step 374 (S374), the re-processing control section 316 judges as to whether or not the image data (drawing data) is printed in the double-side printing manner.

When the image data (drawing data) is printed in the double-side printing manner, since the page number must be changed, the process of the RIP/color correcting program 34 is advanced to a process of a step S378. Whereas, in other cases than the above-described step, the process thereof is advanced to another process of a step S376.

In the step 376 (S376), the re-processing control section 316 judges a to whether or not the image data (drawing data) contains a page number and this page number is changed.

When the page number is changed (see FIGS. 19 and 21), the process of the RIP/color correcting program 34 is advanced to a process of a step S378. Whereas, in other cases than the above-described step, the process thereof is advanced to another process of the step S380.

In the step 378 (S378), the re-processing control section 316 sets all of image data (drawing data) following the page containing the correcting portion as a target of the re-RIP processing.

In the step 380 (S380), the re-processing control section 316 judges as to whether or not the RIP processing can be executed with respect to only the correcting portion.

When the RIP processing only for the correcting portion can be executed (see FIG. 16), the process of the RIP/color correcting program 34 is advanced to a process of a step S384. Whereas, in other cases (see FIGS. 15 and 17) than the above-described step, the process thereof is advanced to another process of a step S382.

In the step 382 (S382), the re-processing control section 316 sets the page containing the correcting portion as a target of the re-RIP processing.

In the step 384 (S384), the re-processing control section 316 sets the correcting portion as a target of the re-RIP processing.

In the step 386 (S386), the re-processing control section 316 determines the above-described target portions of the re-RIP processing, which are set in the processes of the steps S362, S372, S378, S382, and S384, as the targets of the re-RIP process.

In the step 388 (S388), the RIP processing section 310 executes the RIP processing with respect to the portions of the image data (drawing data), which are determined as the target of the re-RIP processing. Furthermore, while the respective processes following the step S326 shown in FIG. 26 are executed, the color correcting processing section 312 executes the color correcting processing with respect to the image data, which is obtained as a result of the re-RIP processing, if necessary.

When the above-described processes for all of the correcting portions are finished, the image processing server 3 controls the printer 24 to print this image data.

In other words, the image data stored in the drawing data DB 306 is synthesized with the re-processed image data by the synthesizing processing section 340. Then, the synthesized image data is once stored in the drawing data DB 306.

The image data, which has been synthesized and stored in the above-described manner, is again read from the drawing data DB 306 and is output to the printer 24.

The above-described storing and reading are required when either the re-processing speed or the synthesizing-processing peed cannot be reached to the required speed of the printer 24.

On the other hand, when total number of the correcting portions is small, since the re-processing speed and the synthesizing-processing speed are faster than the processing speed of the printer 24, the re-processing control section 316b can directly output the corrected data and the source image data to the printer 24 while the re-processing control section 316 synthesizes the corrected image data with the original image data.

Even in this case, the synthesized image data is stored in the drawing data DB 306 in order to be utilized in a process subsequent to the above-explained process.

It should also be noted that the process shown in FIG. 27 maybe applied not only to the RIP processing, but also other processes such as the color correcting processing.

A case in which the process of FIG. 27 is executed on the side of the image processing server 3 has been described. Alternatively, a process for determining a target to be processed by a re-RIP processing may be executed on the side of the client PC 20.

The charging method for the re-RIP processing includes various sorts of methods such as a method in which when total page number is increased due to execution of the re-RIP processing, only an increased page is to be charged, a method for charging for all pages, which should be processed by the re-RIP processing; or a method for charging for an area of an image.

Alternatively, when the re-RIP processing is executed within a predetermined time period after a first RIP processing have been executed, a charging amount for this re-RIP processing may be discounted, or may be made free.

As described above, the case for printing the image data has been described. Alternatively, the re-RIP processing according to the invention may be applied to another image processing, for instance, an image processing of the client PC 20 to display image data on the input/display apparatus 106 (FIG. 2).

Also, the difference processing and the synthesizing processing, which are executed when a correction is made currently, are limited only to a case where the server side executes these processings. Alternatively, place where these functions are realized is not limited only to the server side. For example, a client PC including these functions may directly instruct a printer to perform a printing processing.

[Fourth Embodiment]

A fourth embodiment of the invention will now be explained.

[Outline of Fourth Embodiment]

First, a description will now be made on an outline of the fourth embodiment.

For instance, we cannot make a printing machine, which can execute printing up to certain resolution, print an image having higher resolution than the certain resolution to obtain a normal printing result.

For example, when the printing machine prints an image containing a narrow line (hair line) drawn in high resolution exceeding the printing capability, this hair line cannot be printed normally.

When an RGB image is mixed with a layout image, the RGB image may be printed as a black (K) image.

Similarly, when a printing machine prints an image, which has been compressed in accordance with the EPS-JPEG method, a portion of the EPS-JPEG image may be printed as an image of a black (k) color.

Furthermore, when an image and a document (will also be referred to as an objects hereinafter) are contained in image data, the object may be printed with being overlapped with another object (overprinted).

The fourth embodiment of the invention is devised in the following point. Image data is inspected before executing the RIP processing to detect a portion (print in applicable portion), which may cause trouble as described above, from the image data. Separately from the RIP processing, it is possible to charge for the detection processing itself.

Also, the fourth embodiment of the invention is further devised in the following point. The print inapplicable portion and a print applicable portion, which can be printed normally, are divided. Then, the RIP processing and the printing processing are executed.

In other words, according to the fourth embodiment of the present invention, when a print inapplicable portion is printed, which is corrected so as to be applicable to printing, or when a print inapplicable portion is directly printed, the RIP-processing is executed with respect to these print inapplicable portions. Then, these RIP-processed print inapplicable portions are synthesized with a print applicable portion, which has already been RIP-processed, so that the synthesized portion can be printed.

Due to the devisal, it is possible to detect defects at a time of inputting the image data before printing. Also, this defect detecting processing and the RIP processing can be charged separately. Thereby a flexible charging processing can be realized.

[Third Rip/Color Correcting Program 36]

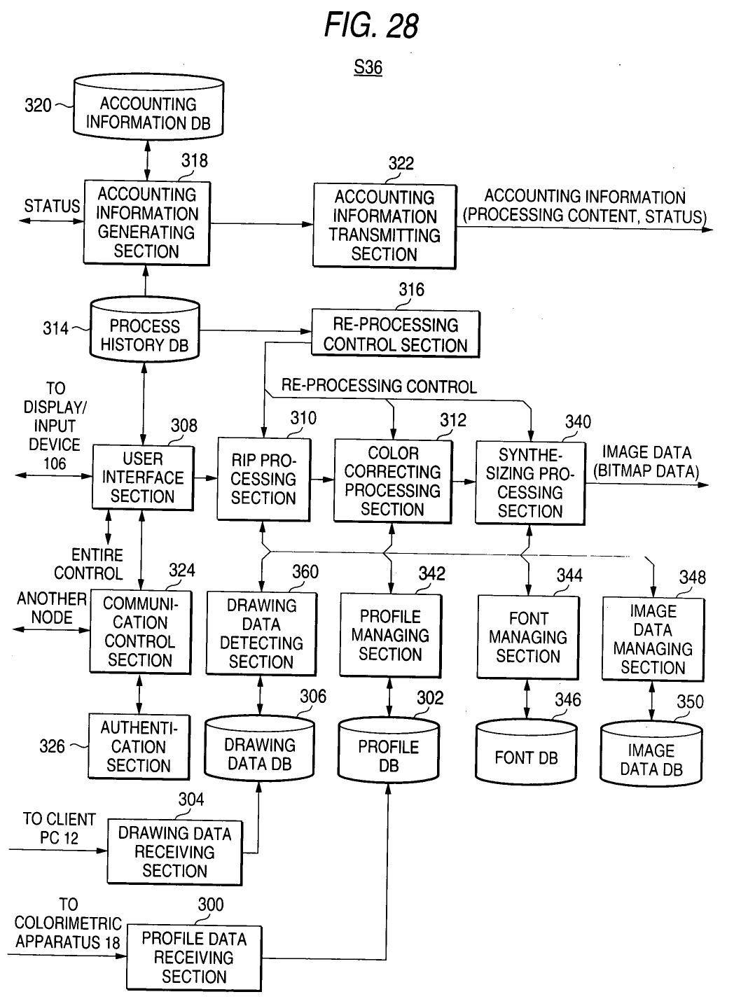

FIG. 28 is a diagram for showing a configuration of a third RIP/color correcting program 36. The third RIP/color correcting program 36 is operated on the image processing server 3 (FIG. 14) in the second print system 2, and executes a checking processing and an RIP processing with respect to image data.

It should be noted that the same reference numerals shown in the structural components of the first and second RIP/color correcting programs 30 and 34 shown in FIGS. 4 and 22 will be employed as those for denoting the essentially same structural components of the third RIP/color correcting program 36 shown in FIG. 28.

As shown in FIG. 28, this third RIP/color correcting program 36 is configured so that a drawing data checking section 360 is added the configuration of the second RIP/color correcting program 34 shown in FIG. 22.

In the third RIP/color correcting program 36, drawing data stored in the drawing data DB 304 is checked. If the portion/object, which are not applicable to printing operation (, print inapplicable portion), is contained in this checked drawing data, this print inapplicable portion is detected.

[Operation Of Third Rip/Color Correcting Program 36]

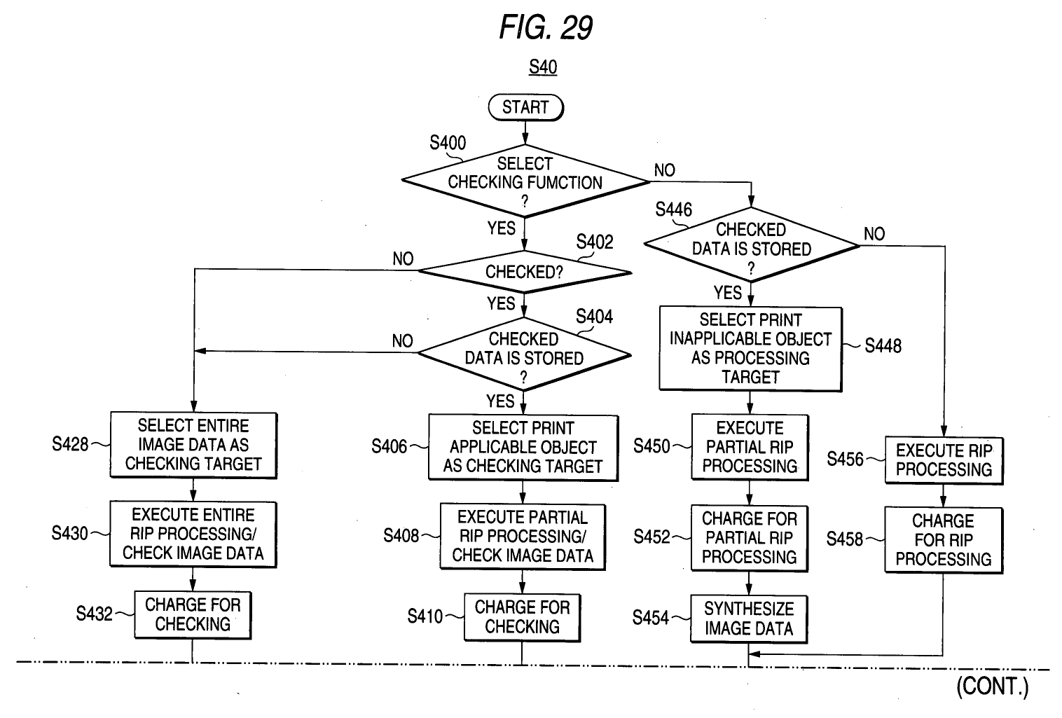

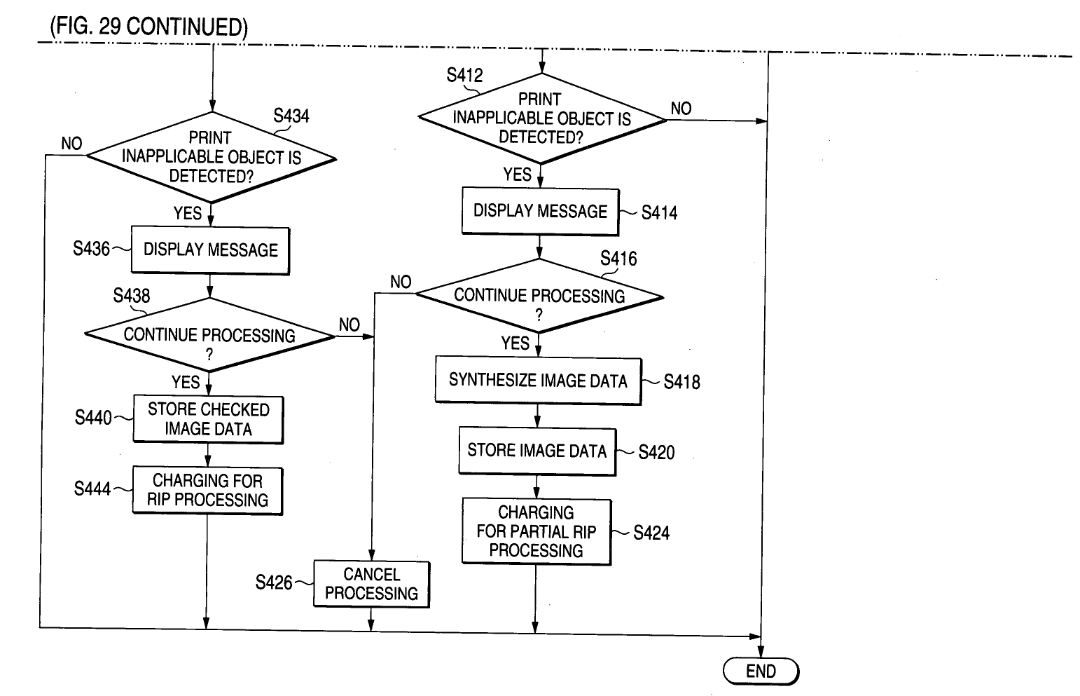

FIG. 29 is a flow chart for showing a process (S40) of the third RIP/color correcting program 36 shown in FIG. 28.

The process of the third RIP/color correcting program 36 will now be described. A case in which a print applicability of the printing machine 142 is checked is taken as a specific example.

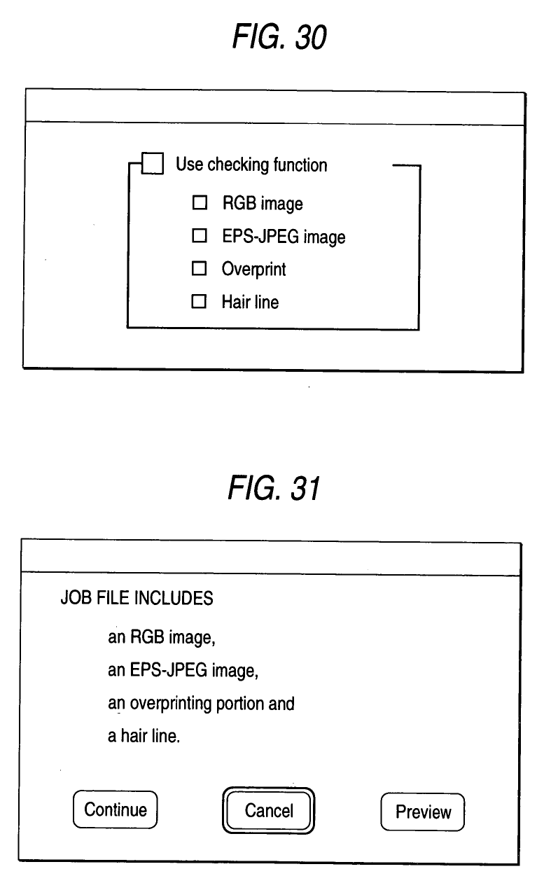

FIG. 30 is a diagram for showing a check function selecting image displayed by the third RIP/color correcting program 36 shown in FIG. 29.

FIG. 31 is a diagram for showing a check result display image, which is displayed when the third RIP/color correcting program 36 shown in FIG. 29 detects a print inapplicable portion from drawing data.

We may handle the process shown in FIG. 29 by approximately subdividing it into four portions, namely, a first process from a step S456 to a step S458; a second process from a step S446 to a step S454; a third process from a step S402 to a step S424; and a fourth process from a step S428 to a step S444.

Of these four process portions, the first process corresponds to the normal RIP processing, which does not use the check function.

Also, the second process corresponds to a process executed in a case where while the check function was executed in the previous process, RIP-processed data containing a print inapplicable object and data indicating a detailed content of this process result have been stored.

Also, the third process corresponds to a process executed in a case where while the check function is executed in the present process, RIP-processed data containing a print inapplicable object and data indicating a detailed content of this process result have been stored.

Such a process may be repeated several times by the user.

In the third process, when an object judged as a print inapplicable object in the previous process is eliminated and as a result of an execution of a partial RIP processing at the present time, a new print inapplicable object is detected, the processed data, which is obtained in the previous process and corresponds to this new print inapplicable object, is synthesized with a portion of the new print inapplicable object, and then, the synthesized data is again stored.

The fourth process corresponds to a process executed in either a case where the check function is newly selected and is executed in the present time, or a case where even if the checking processing was executed in the previous process, a result of this checking processing is not stored. It should be noted that the below-mentioned process of a step S400 corresponds to a judgment as to whether or not a checking processing had been executed in the past. Also, a process of a step S402 corresponds to a judgment as to whether or not stored data is present.

In the fourth process, the checking processing and the RIP processing are executed and then, the charging processing for both the checking processing and the RIP processing are executed.

It should also be noted that in the following description, it is assumed that a synthesizing processing is executed with respect to a plurality pieces of image data, which have been RIP-processed.

As shown in FIG. 29, in a step 400 (S400), the UI section 308 displays, for instance, the check function selecting image shown in FIG. 30 on the input/display apparatus 106 (FIG. 2) of the client PC 20 (FIG. 14).

A user of the client PC 20 operates the images displayed on the input/display apparatus 106, and selects as to whether or not he/she uses the check function with respect to the image data (drawing data) by checking a button of “using check function”.

Furthermore, the user of the client PC 20 selects a check item by checking buttons of items, which he/she wants to check. These items correspond to an RGB image, an EPS-JPEG image, an over print, and a hair line.

When the user selects an execution of the check function, the process of the third RIP/color correcting program 36 is advanced to a process of a step S402. Whereas, in other cases than the above-described case, the process is advanced to another process of a step S446.

In the step 402 (S402), the drawing data checking section 360 retrieves the image data DB 350, and judges as to whether or not a job (image data), which is presently checked in the process of this step S402, has already been checked and stored.

When the image data, which has been checked, is present, the process of this third RIP/color correcting program 36 is advanced to a process of a step S404. Whereas, in other cases than the above-described cases, the process thereof is advanced to another process of a step S428.

It should also be noted that in the process of the step S402, the judgment is made as to whether or not the RIP-processed data (rasterized bitmap data), which has been stored in the image data DB 350, and the data indicating the detailed process result accompanied with this rasterized bitmap data are present. This data contains information as to whether or not the data in question is located in any file of the job files.

When the judgment result becomes yes in the process of the step S400, that is, the check function is selected, in the process of the step S402, the judgment is made as to whether or not a job, which is to be processed in this step, has previously been checked and whether or not this check result has been stored.

When the RIP-processed data and the data accompanied with this RIP-processed data are stored in the image data DB 350, the judgment result of the step S402 becomes “YES”. Then, a process of a step S406 is executed.

Furthermore, in a process of a step S408, a checking processing is executed with respect to any object other than the print inapplicable object, which was detected in the previous checking processing.

In a step 404 (S404), the drawing data checking section 360 judges as to whether or not the checked image data (drawing data; RIP-processed drawing data) has been stored in the image data DB 350.

When the checked image data (RIP-processed drawing data) has been stored, the process of the third RIP/color correcting program 36 is advanced to a process of a step S406, whereas in other cases than the above-described case, the process thereof is advanced to another process of a step S428.

In the step 406 (S406), the drawing data checking section 360 selects an object (print applicable object), which was determined as an object applicable to a printing by the printing machine 142 in a previous checking, as a checking target from among image structural portions (will also be simply referred to as “objects” hereinafter) such as an image object and a document object, which constitute the checked image data (drawing data).

In a step 408 (S408), the drawing data checking section 360 judges as to whether or not an RGB image, which was set as a checking target in the process of the step S400 and is not applicable to the printing processing by the printing machine 142, is contained in the print applicable object, which was checked in the process of the step S406.

It should be noted that a checking processing and a partial RIP processing should be executed in an integral form. The partial RIP processing is executed in the process of the step S408.

The re-processing control section 316 controls the structural components of the third RIP/color correcting program 36 to execute an RIP processing (partial RIP processing) with respect to the print applicable object, which was checked in the process of the step S406.

The re-processing control section 316 stores a result of this partial RIP processing in the process history DB 314 as a processing log.

It should also be noted that this partial RIP processing may be realized by performing a proper change, for example, either a print inapplicable portion or a print applicable portion is processed by the re-RIP processing.

In a step 410 (S410), the drawing data checking section 360 stores necessary data such as the check result in the process history DB 31′ as a processing log.

The accounting information generating section 318 generates accounting information on the check process based on this processing log and the accounting table stored in the accounting information DB 320 and then, outputs this generated accounting information to the charging server 4.

The charging server 4 charges the client PC 20 based on the accounting information.

In a step 412 (S412), the drawing data checking section 360 judges as to whether or not a print inapplicable object is detected.

When the print inapplicable object is not detected, the UI section 308 displays this fact on the input/display apparatus 106 (FIG. 2) of the client PC 20, and then terminates the process, whereas in other cases than the above-explained case, the process of the third RIP/color correcting program 36 is advanced to a process of a step S414.

In the step 414 (S414), the UI section 308 displays an image indicating the check result (as shown in FIG. 31) on the input/display apparatus 106 (FIG. 2) of the client PC 20 to represent the print inapplicable object, which has been detected as the check result, to the user of the client PC 20.

In a step 416 (S416), the UI section 308 judges as to whether or not the user of the client PC 20 instructs a continuation of the process.

When the user instructs to continue the process, the process of the third RIP/color correcting program 36 is advanced to a process of a step S418, whereas in other cases than the above-described case, the process thereof is advanced to another process of a step S426. The instruction to continue the process made by the user of the client PC 20 may be realized by selecting either a button of “continue” or another button of “cancel” shown in a lower portion of FIG. 31. When the user selects the button of “continue”, the process is continuously executed, whereas when the user selects the button of “cancel”, the process is interrupted.

In steps 418 and 420 (S418 and S420), the re-processing control section 316 controls the synthesizing processing section 340 to synthesize the print applicable object (RIP-processed object), which has been checked in the process of the step S406, with the print inapplicable object (RIP-processed object) corresponding to this print applicable object, and then, stores the synthesized image data in the image data DB 350.

In a step 424 (S424), the accounting information generating section 318 generates accounting information on the partial RIP processing based on this processing log and the accounting table stored in the accounting information DB 320 and then, outputs this generated accounting information to the charging server 4.

The charging server 4 charges the client PC 20 based on this accounting information.

In a step 426 (S426), the third RIP/color correcting program 36 executes a process, which is required to cancel subsequent processes for the image data (drawing data).

In a step 428 (S428), the drawing data checking section 360 sets an entire portion of the image data (drawing data) as a checking target.

In a step 430 (S430), the drawing data checking section 360 executes the checking processing with respect to the entire image data, and then, stores a processing log of a check result into the process history DB 314.

As described above, since the checking processing and the RIP processing are executed in the integral manner, in the process of the step S428, the re-processing control section 316 controls the respective structural components of the third RIP/color correcting program 36 to execute the RIP processing with respect to the entire image data (drawing data).

The re-processing control section 316 stores a result of this RIP process in the process history DB 314 as the processing log.

In a step 432 (S432), the accounting information generating section 318 generates accounting information on the checking process based on the processing log and the accounting table stored in the accounting information DB 320, and then outputs this generated accounting information to the charging server 4.

The charging server 4 charges the client PC 20 based on this accounting information.

In a step 434 (S434), the drawing data checking section 360 judges as to whether or not a print inapplicable object is detected.

When the print inapplicable object is detected, the process of the third RIP/color correcting program 36 is advanced to a process of a step S436, whereas in other cases than the above-described case, this third RIP/color correcting program 36 displays this fact on the input/display apparatus 106 of the client PC 20, and then terminates the process.

In a step 436 (S436), the UI section 308 displays the image shown in FIG. 31, to indicate the detected print inapplicable object to the user of the client PC 20.

In a step 438 (S438), the UI section 308 judges whether or not the user of the client PC 20 instructs to continue the process in a similar manner to that of the previous process of the step S416.

When the user instructs to continue the process, the process of the third RIP/color correcting program 36 is advanced to a process of a step S440, whereas in other cases than the above-described case, the process thereof is advanced to the process of the step S426.

In the step 440 (S440), the drawing data checking section 360 stores the checked image data (RIP-processed image data) in the image data DB 350.

In a step 444 (S444), the accounting information generating section 318 generates accounting information on the RIP process based on this processing log and the accounting table stored in the accounting information DB 320, and then outputs this generated accounting information to the charging server 4.

The charging server 4 charges the client PC 20 based on this accounting information.

In a step 446 (S446), the drawing data checking section 360 judges as to whether or not the checked image data has been stored in the image data DB 350.

When the checked image data (RIP-processed image data) has been stored in the image data DB 350, the process of the third RIP/color correcting program 36 is advanced to a process of a step S448, whereas in other cases than the above-described case, the process thereof is advanced to another process of a step S456.

In the step 448 (S448), the drawing data checking section 360 selects a print inapplicable object as a target of the partial RIP processing.

In a step 450 (S450), the re-processing control section 316 controls the structural components of the RIP/color correcting program 36 to execute the partial RIP processing with respect to the print inapplicable object, which has been selected as the target for the RIP process in the process of the step S448.

In a step 452 (S452), the re-processing control section 316 controls the structural components of the RIP/color correcting program 36 to store a result of the partial RIP processing in the process history DB 314 as a processing log.

In a step 452 (S452), the accounting information generating section 318 generates accounting information on the partial RIP process based on the processing log and the accounting table stored in the accounting information DB 320, and then outputs this generated accounting information to the charging server 4.

The charging server 4 charges the client PC 20 based on this accounting information.

In a step 454 (S454), the re-processing control section 316 controls the synthesizing processing section 340 to synthesize image data, which is obtained as a result of the partial RIP processing with respect to the print inapplicable object, with another image data, which is obtained as a result of the RIP processing with respect to the print-applicable object. Then, the re-processing control section stores the synthesized image data in the image data DB 350.

In a step 456 (S456), the RIP processing section 310 executes an RIP processing with respect to the entire image data (drawing data), and stores this process result in the process history DB 314 as a processing log.

In a step 458 (S458), the accounting information generating section 318 generates accounting information on the RIP process based on this processing log and the accounting table stored in the accounting information DB 320, and then outputs this formed accounting information to the charging server 4.

The charging server 4 charges the client PC 20 based on this accounting information.

As described above, the charging system and the charging method according to the embodiments of the invention can provide the process function to a user, and charges for each process flexibly in response to the process mode.

What is claimed is:

1. A charging system comprising:
a process apparatus for executing a plurality of predetermined processings; and
a charging apparatus for charging for each executed processing, wherein:
the process apparatus includes:
an information generation unit for generating process information indicating contents of the executed processings and status information indicating execution status of the processings; and
an information transmission unit for transmitting the generated process information and the generated status information to the charging apparatus;
the charging apparatus includes:
an information reception unit for receiving the transmitted process information and the transmitted status information;
a fee calculation unit for calculating a fee for each executed processing on the basis of the received process information;
an accounting amount determination unit for determining the calculated fees as an accounting amount when the received process information indicates that the executed processings are completed normally; and
a charging unit for executing a charging processing on the basis of the determined accounting amount.

2. The charging system according to claim 1, wherein the accounting amount determination unit changes the calculated fees and determines the changed fees as the accounting amount when the process information does not indicate that the executed processings are completed normally.

3. A charging apparatus for charging for each predetermined processing, which a process apparatus executes, wherein the process apparatus generates process information indicating contents of the executed processings and status information indicating execution status of the processings, the charging apparatus comprising:
an information reception unit for receiving the process information and the status information;
a fee calculation unit for calculating a fee for each executed processing on the basis of the received process information;
an accounting amount determination unit for determining the calculated fees as an accounting amount when the received process information indicates that the executed processings are completed normally; and
a charging unit for executing a charging processing on the basis of the determined accounting amount.

4. The charging apparatus according to claim 3, wherein the accounting amount determination unit changes the calculated fees and determines the changed fees as the accounting amount when the processing information does not indicate that the executed processings are completed normally.

5. The charging apparatus according to claim 3, wherein the processings includes at least one of a raster image processing for expanding drawing data into bitmap data, a correction processing for correcting the expanded bitmap data, and a printing processing for printing the bitmap data.

6. The charging apparatus according to claim 3, further comprising:
a provisional accounting amount holding unit for holding the calculated fees as provisional accounting amounts for the executed processings, wherein:
when the process information indicates that the executed processings are completed normally, the accounting amount determination unit determines the held provisional accounting amounts as the accounting amount; and
when the process information does not indicate that the executed processings are completed normally, the accounting amount determination unit changes the held provisional accounting amounts and determines the changed provisional accounting amounts as the accounting amount.

7. A charging method for charging for each predetermined processing, which a process apparatus executes, wherein the process apparatus generates process information indicating contents of the executed processings and status information indicating execution status of the processings, the charging method comprising:
receiving the process information and the status information;
calculating a fee for each executed processing on the basis of the received process information;
determining the calculated fees as an accounting amount when the received process information indicates that the executed processings are completed normally; and
executing a charging processing on the basis of the determined accounting amount.

8. The charging method according to claim 7, further comprising:
changing the calculated fees and determining the changed fees as the accounting amount when the process information does not indicate that the executed processings are completed normally.

9. The charging method according to claim 7, further comprising:
holding the calculated fees as provisional accounting amounts for the executed processings, wherein:
when the process information indicates that the executed processings are completed normally, the held provisional accounting amounts are determined as the accounting amount in the accounting amount determination step; and
when the process information does not indicate that the executed processings are completed normally, the held provisional accounting amounts are changed and the changed provisional accounting amounts are determined as the accounting amount in the accounting amount determination step.
